(19) United States
(12) Patent Application Publication
(10) Pub. No.: US 2010/0083173 A1
(43) Pub. Date: Apr. 1, 2010

(54) Method and system for applying metadata to data sets of file objects

(76) Inventors: Stephen R. GERMANN, Burlington (CA); Ryan C. GERMANN, Toronto (CA); Steven COOPER, Pickering (CA); Eric MAH, Richmond Hill (CA)

Correspondence Address: DOWELL & DOWELL P.C., 103 Oronoco St., Suite 220, Alexandria, VA, 22314, US

(21) Appl. No.: 12/458,247

(22) Filed: Jul. 6, 2009

Related U.S. Application Data
(60) Provisional application No. 61/129,542, filed on Jul. 3, 2008.

(51) Int. Cl. G06F 3/048; G06F 17/30

(52) U.S. Cl. 715/810; 715/853; 707/805; 707/E17.044

(57) ABSTRACT

The present invention generally relates to the methods and systems for developing, specifying, and assigning descriptive information relating to the contents of a file (i.e., metadata). User interface controls on a computer screen implement a dynamically changing display which responds to user input by presenting new categories of choices. Additional controls allow optimization of the process of specifying and assigning descriptive metadata.

### CROSS-REFERENCE TO RELATED APPLICATIONS

This application claims the benefit of U.S. Provisional Application No. 61/129,542, filed Jul. 3, 2008, which is incorporated herein by reference in its entirety.

### REFERENCE TO COMPUTER PROGRAM LISTING APPENDIX

This application incorporates by reference the material included on the two compact discs submitted as a computer program listing appendix. The two compact discs are identical and labelled as Copy 1 and Copy 2, respectively. Each disc includes a computer program listing file entitled source_code_listing.txt, and a folder named “source_code,” which contains a plurality of source code files, as well as instructions for using the source code files build the computer program. Both discs were created on Jul. 6, 2009, and each disc is 152 KB in size.

### FIELD OF THE INVENTION

The present invention relates to the methods and systems for developing, indicating, specifying, and assigning descriptive information relating to the contents of a file. The invention further relates to associating metadata with a file, where the metadata is provided in a hierarchal structure.

### BACKGROUND OF THE INVENTION

Metadata is broadly defined as “data about data” i.e. a label or description. Thus, a given item of metadata may be used to describe an individual datum, or a content item, a given item of metadata can be used to describe a collection of data which can include a plurality of content items.

The fundamental role of metadata is used to facilitate or aid in the understanding, use and management of data. The metadata required for efficient data management is dependent on, and varies with, the type of data and the context of use of this data. Using as an example a library, the data is the content of the titles stocked, and the metadata about a title would typically include a description of the content, and any other information relevant for whatever purposes, for example the publication date, author, location in the library, etc.

For photographic images, metadata typically labels the date the photograph was taken, whether day or evening, the camera settings, and information related to copyright control, such as the name of the photographer, and owner and date of copyright. Conventional metadata has existed for as long as items have had names. In the case of a photograph on a piece of paper, writing the date on the back of the photographs is a type of metadata. In cases in which the data is describing the content of computer files, metadata about an individual data item could include, but is not limited to, the name of the file and its length. Thus metadata about a collection of data items in a computer file typically includes the name of the file, the type of file, etc.

Novice computer users have access to “giga computers” (gigabyte storage, gigahertz power) which can overwhelm their ability to access their stored data. Digital photos, video clips, and music files are easy and inexpensive to create, but hard to identify programatically. Users are being forced to cope with many types of digital assets beyond conventional searchable text, namely video clips, web pages, music/audio files, word documents, spreadsheets, and various vertical applications thereof (pop music vs. classical music, personal photo library vs. professional photography, etc).

Various vendors have attempted to integrate increasingly sophisticated search technologies into the operating system or main operating interface of desktop computers. Unfortunately, such search technologies lack the breadth of knowledge of the cultural and emotional significance of subject matter that is required to identify appropriate results.

The value of a search result is not how many results it returns, but how few, and how accurate those few results are; that is, if a search result includes every file on a user's computer, unordered, it has no value. Existing search technologies do not succeed at correctly identifying contents of digital assets accurately: the search result is inaccurate, either returning far too few results, or far too many, neither of which is acceptable in most situations. Any data file that is not accessed has little value. Once stored, if never accessed, the value of a digital photo or music file is limited. Consumers who purchase digital cameras or media playback devices become dissatisfied with the technology when they realize the amount of effort required to organize the data. Indeed, figuring out the correct subset of files to transfer to their player device is labour intensive, because there is no automated search mechanism capable of identifying the contents of digital media files.

That is where metadata is particularly useful: the user cannot rely on pattern detection algorithms to identify and return the correct results to a user-directed search. That leaves the user with two alternatives: 1) continue to struggle with manual file management techniques until the pattern detection algorithms are sophisticated enough to return accurate results, or; 2) assign computer-processable metadata to the digital media files such that accurate search results can be returned.

Attempts to provide metadata by manual means are tiring and demand not only an expert user from a mental point of view, but also a degree of endurance and physical dexterity. Due to these difficulties, users will gather metadata determined by automated technologies, or from third parties via internet-based sources, even though the user may still have to correct the metadata for accuracy (the original tagging was incorrect) or just to suit their own metadata naming conventions.

A user interface for assigning computer-processable metadata to the digital media files should ideally have the following characteristics:
1. It should allow users of moderate skill to create limited metadata vocabularies using specific terms and a phrases that are easily understood by themselves and their associates, therefore having greater value than terms and phrases chosen by third-parties and adapted from other uses;
2. It should guide users to create metadata vocabularies that use “best practices” during the creation process, so the metadata vocabulary is sound both structurally and semantically;
3. It should provide tools that allow for collaborative creation of metadata vocabularies;
4. It should provide integrated documentation for every field and value in the metadata vocabulary;
5. It should provide integrated guidance for collaborators to extend the metadata vocabulary in a compatible, approved way;
6. It should provide revision control and distribution mechanisms for metadata vocabularies;
7. It should provide mechanisms to establish “synonym” relationships between two or more tags within a given metadata vocabulary, and between a specific tag or tags in two or more metadata vocabularies;
8. It should allow individual users to restructure the metadata presentation (appearance on their computer screen) to better meet their particular requirements, without altering the general semantic context of the metadata vocabulary;
9. It should provide users with efficient and streamlined user-interfaces for application of metadata to files;
10. It should store the metadata in the files so wherever the file is moved or copied to, machine processable metadata travels with it;
11. It should provide multiple, intuitive search interfaces to leverage metadata: highly accessible “simple text” search and highly accurate “context-sensitive” search.

“State of the art” image and music management tools lack most of these capabilities by design: tools that focus on file editing and playback offer only rudimentary interfaces for metadata management: metadata management is a small subset of those applications' overall feature set. The current state of the art does not attempt to overcome the following problems with user-assigned metadata.

One problem is the lack of management of discovered metadata (found embedded in files imported to the users file library from a third party source). For example, when a user receives photos from someone else, existing applications do not provide a means to establish provenance and what to do with the incoming metadata. Decisions made by the user with regard to the correct position in a structured tag hierarchy are not remembered for the next time that same tag is encountered (in another batch of photos, for instance). For example, the same tag will appear in the Microsoft Windows Vista Photo Gallery tag tree at the top level again and will need to be moved manually to the correct position to update the embedded tags.

Adobe Photoshop Elements offers a number of features that appear to support structured tag vocabularies, but are limited in a number of ways:
1. Tags may only be processed as structured tags within the Adobe Photoshop Elements application (the tags embedded in files are not structured at all).
2. Due to the problems related to item 1), the use of homoglyphs is forbidden: the same exact word or phrase can only appear once in the entire tag hierarchy, undermining the value of structured metadata, since the parentage of the word does not qualify its meaning.
3. Photoshop Elements allows one to save out one's metadata vocabulary and share it in a standards-based XML (eXtensible Markup Language) format file, but there is no integrated way for the originator to associate documentation with it: there is no value added at the source. In order for the recipient of the tag vocabulary to make proper use of the tags, the originator must devise a documentation scheme and the recipient user must be able to accept that documentation in the scheme provided. The inventions described herein include specifications for integrated metadata documentation.

Furthermore, other tools do not guide the user to enter keywords or labels in a way that is usable for search. For example, the user may be encouraged to provide a natural-language caption, but such natural language phrases are not easily discovered by mainstream search technologies. Keyword search integrated at the operating-system level includes file names/path fragments as part of the source data that is searched, which is subject to misinterpretation out of the context of the designated metadata set, so it is likely that irrelevant files will be returned in the result, therefore diluting the value of ‘keywords’. The user is not guided to create metadata in a sensible, manageable, ‘future proof’ way.

In a sense, desktop search tools help one find things that have been carelessly managed: the inventions described herein are about ensuring files are properly managed in the first place, and assisting the user in maintaining the integrity of the aggregate metadata over time. The inventions described herein also help the user to get badly managed files into a ‘properly managed’ state.

Current metadata systems do not support multi-language ‘synonyms’ or ‘translations’. Some available programs use “Unicode” so other codepage-based operating systems will be able to render the characters properly, but that is simply a mechanism allowing for any language to be used when keying in the terms. It does nothing to associate semantically identical terms from different languages or with different spellings with one another properly. Furthermore, by the very nature of unstructured keywords, a given word has many different synonyms depending on its context. Use of a structured vocabulary can allow words to be assigned the proper synonym in other languages without having to include many irrelevant possible synonyms that would result from translating every word in the thesaurus entry for the first word.

While almost every existing software application that bills itself as a “digital asset manager” or “media file manager” offers some sort of metadata entry, the scope of the metadata supported is limited to a specific set of fields. The data entry mechanism is manual (typing) and these software application tools do little or nothing to optimize the tagging activity. Innovation on the part of the vendors of such tools comes in the selection of standard fields made available for use, the way fields are arranged on the forms, or the combination of user interface controls used. Little has been done to provide users with tools that address the metadata workflow and the integrity of the metadata library over the long term, in due consideration of what motivates users to enter metadata (the value of tagging). Little has been done to optimize workflow in support of fixing metadata that is incorrect; this process has shared requirements but other distinct requirements compared to those related to adding metadata to files from scratch.

Furthermore, considering the use of simple text keywords and description assignment, the user simply types in any word or phrase that occurs to them and interfaces do not present a catalog of previously-used tags and phrases. This has the problematic consequence of not providing the user with the benefit of a standardized metadata vocabulary which the user can employ consistently. Additionally, such flat ‘keyword’ methods provide no ‘context’ for keywords. To their disadvantage, the only search method available to them will be a simple text search which will inevitably return false positives and fail to return appropriately limited synonym matches. There exist complex natural-language search engines and sophisticated search-algorithm composition tools, but the configuration and use of them is beyond the capabilities of most non-technical users.

With regard to the use of pre-configured metadata vocabularies, the user must gain a sufficient understanding of the semantic meaning of every field and possible value, if field values are restricted to a limited range of values or choices. Novice users will not understand the potential value of the investment in learning a pre-configured metadata vocabulary. In fact, only by learning about the vocabulary may the user discover it is inappropriate for their use, which is a 100% wasted effort. If field values are not restricted, novice users who have not developed the insights to properly plan and establish a method of expanding and adding to the vocabulary for their own use will be subject to problems that arise with inconsistent and/or incomplete tagging.

There are many file managers which support the ability to apply metadata to files. These range in complexity from those which simply offer text boxes and accept user typed input, to systems which implement a tree of multi-level nested keywords, either defined by the user or provided as a controlled vocabulary, and allow the user to apply selected keywords to the files.

One way currently in use is to employ a tree control, which can be expanded and collapsed on a node-by-node basis, and represent icons on each node in the tree. When representations of files (such as thumbnail images of photos) are selected in a file browser part of the application, the icons on nodes in the metadata tree change to represent the embedded metadata in the selected file(s).

There is the ability to show, on a per node basis, whether none, some, or all of the files in the selection contain the node's metadata item. The user can then operate checkboxes or change the icons on the nodes, while browsing the tree, and whatever changes are made to the checkboxes will be associated with the metadata of the photos.

The tree-based user interface is used for photos in ‘Windows Photo Gallery’, and is understandable to some users. However, it requires a significant amount of dexterity in mouse movements and multi-file selection, and browsing of the tree nodes to examine the available metadata for use in tagging files, and to ensure that the metadata assigned to files is correct.

In addition, the need to study the set of thumbnails (which are small, although resizable) and make decisions based on what is seen, in order to determine which photos to include in the selection, also is a burden on the user, and it is possible that this will cause eye strain. Thumbnail inspection is error prone and unforgiving, since neglecting to select an image before applying a certain keyword will result in the need to select it later and perform again the steps needed to apply that keyword. Almost the same amount of tree navigation effort for keyword selection will be required during the cleanup phase even though only one image is being tagged.

One additional problem with this approach is that it is difficult for the user to detect whether the focus is sharp and the exposure is correct on an image by looking at a thumbnail, since the details are compressed when a thumbnail image is created. Mousing over each item to get a larger view also is time consuming, and is difficult to do diligently.

Finally, the need to create multiple selections over and over to tag one set of photos is inefficient, as the same thumbnails will have to be examined again and again, for instance, to determine if certain people are present in the image. All of the above argues against methods of batch-tagging which require the user to repeatedly select subsets of files for application of a small number of tags, where there will be multiple passes before all the tags are applied.

In summary, present methods and applications for applying metadata tags to digital media and other files suffer from numerous technical problems and deficiencies that prevent their widespread among the broader user community. What is needed are technical solutions to these problems that overcome the aforementioned drawbacks and provide metadata tagging methods and user interfaces that adapt to efficient workflow and community sharing.

### SUMMARY OF THE INVENTION

The present invention provides an improved method and system for applying and/or associating metadata with files. Embodiments of the present invention provide metadata management wherein all the features in the application and user interface serve the task of creation and assignment of metadata, and the returning of accurate search results.

The invention solves a key technical problem in the prior art and provides a solution in that delivers dramatically increased efficiency and utility in the management of metadata associated with files in a computer or related system. In some embodiments, the method of associating metadata tags according to the invention enables a computer user to subsequently search and identify files with significantly improved efficiency and accuracy. In particular, the invention enables users to have improved access to stored or archived files by providing a new guided method for the association of a structured set of metadata with a file.

In a preferred embodiment, the present invention solves the aforementioned problems in the prior art by providing a method for the association of metadata tags with a file, where the metadata tags are provided in a set of tags that are arranged in a hierarchal structure with nested tag node subsets, and where individual tag node subsets are sequentially presented to the user for the selection of tags to associate with the file. The set of tag nodes is organized into a set of primary tag nodes, which have dependent tag nodes that are either intermediate tag nodes, to which further tag node subsets belong, or leaf tag nodes, which terminate the hierarchal structure.

Unlike prior art methods of managing and associating metadata, the present invention provides an improved method in which the selection of a tag node by the user results in a further action without the need for additional user input. In a preferred embodiment, the method is initiated with the user being presented with a tag node subset belonging to a first primary tag node. The user may then select a tag node from the presented tag node subset.

If the user selects a leaf tag node (terminating the hierarchal structure), then the selection of such a node by the user preferably causes the selected tag node to be associated with the file, and also results in the user being presented with a new set of tag nodes corresponding to another primary tag node (preferably one that had not yet been presented to the user). Alternatively, if the user selects an intermediate tag node to which an additional tag node subset belongs, then the additional tag node subset is presented to the user without requiring further user input, and this is repeated until a leaf node is selected. Preferably, during the preceding step, the user may skip ahead to another primary tag node without having to select a leaf node.

The above steps are repeated until the user has had the opportunity to associate tags belonging to all primary tag nodes, or until the user terminates the tag selection process with an optional user control.

Accordingly, the invention provides a computer readable medium encoded with computer-executable instructions which, when executed by a computer, perform a method of associating a file with one or more metadata tags, the method comprising:

a) displaying to a user a metadata user interface for the selection of said one or more metadata tags from a set of tags, wherein said set of tags comprises a hierarchal structure with one or more nested tag node subsets;

b) activating a first primary tag node as an active tag node;

c) presenting a tag node subset belonging to said active tag node to said user and receiving input from said user, wherein said user may select a tag to associate with said file by selecting a leaf tag node, or said user may modify said active tag node by choosing an intermediate tag node or a primary tag node, wherein said chosen tag node is activated as said active tag node;

d) repeating step (c) until a leaf tag node is selected;

e) activating as an active tag node a primary tag node that had not been activated in a previous step, and subsequently repeating (c)-(d), until all primary tag nodes have been activated or until said method is terminated by an optional user control; and

f) associating said selected metadata tags with said file.

In a preferred embodiment of the above invention, the user may select a primary tag node as the active tag node subset in steps (b) or (e) above.

In another preferred embodiment, the set of primary and intermediate tag nodes is presented to the user, and the user is guided through a sequential process in which leaf nodes belonging to primary and intermediate tag nodes are presented to the user.

Accordingly, the invention also provides a computer readable medium encoded with computer-executable instructions which, when executed by a computer, perform a method of associating a file with one or more metadata tags, the method comprising:

a) displaying to a user a metadata user interface for the selection of said one or more tags from a set of tags, wherein said set of tags comprises a hierarchal structure with one or more nested tag node subsets, and wherein said set of tags comprises primary tag nodes forming a first tag node subset, intermediate tag nodes, and leaf tag nodes terminating said hierarchal structure;

b) presenting said primary and intermediate tag nodes to said user and receiving input from said user, wherein a selection of a primary or intermediate tag node by said users causes leaf tag nodes belonging to said primary or intermediate tag node to be displayed;

c) identifying a first primary tag node as an active tag node;

d) presenting leaf tags nodes belonging to said active tag node, and receiving input from said user, wherein said user may select a tag to associate with said file by selecting a leaf tag node, wherein said selection of said leaf tag node causes another primary or intermediate tag node to be identified as said active tag node, or wherein said user may choosing a different primary or intermediate tag node to identify as said active tag node; and

e) repeating step (d) until all primary and intermediate tag nodes have identified or until said method is terminated by an optional user control; and

f) associating said metadata tags with said file.

The invention also provides a method for the selection of a set of tags from a superset of tags, where both the set and superset of tags are provided in a set of tags that are arranged in a hierarchal structure with nested tag node subsets. This embodiment of the invention solves a key problem in the prior art, and enables users to be able to associate a subset of tags from a larger set of metadata tags. This has particular utility for users that obtain the superset of tags from a third party, in which case not all tags in the superset may be relevant to the user. By practicing this embodiment of the invention, users can improve the speed and efficiency of the tag association process.

The invention thus provides a user interface embodied on one or more computer-readable media and executable on a computer for the selection of a set of metadata tags from a superset of metadata tags, wherein said superset of tags comprises a hierarchal structure of tag nodes with one or more nested tag node subsets, said user interface comprising:

a presentation area for displaying said hierarchal structure of said superset of metadata tags; and

a selection means wherein said user may select one or more of said tag nodes for inclusion within said set of metadata tags;

wherein said set of metadata tags is stored on a computer readable medium in a dataset comprising a hierarchal structure of tags nodes with one or more nested tag node subsets.

In another embodiment of the invention, a method is provided for the association of one or more choices from a structured list of choices with a computer representation of an item.

Accordingly, the invention provides a computer readable medium encoded with computer-executable instructions which, when executed by a computer, perform a method of associating a representation of an item with one or more choices, wherein said representation of said item is encoded on a computer readable medium, and wherein the method comprises:

a) displaying a user interface to a user for the selection of said one or more choices from a set of choices, wherein said set of choices comprises a hierarchal structure with one or more nested node subsets;

b) activating a first primary node as an active node;

c) presenting a node subset belonging to said active node to said user and receiving input from said user, wherein said user may select a choice to associate with said representation of said item by selecting a leaf node, or said user may modify said active node by choosing an intermediate node or a primary node, wherein said chosen node is activated as said active node without requiring further input from said user;

d) repeating step (c) until a leaf node is selected;

e) activating as an active node a primary node that had not been activated in a previous step, and subsequently repeating (c)-(d), until all primary nodes have been activated or until said method is terminated by an optional user control; and

f) associating said selected choices with said representation of said item.

Broadly speaking, the method of the present invention involves
1. Searching the file system to identify compatible files,
2. Gathering and classifying the metadata associated with those files,
3. Presenting the metadata to the user for examination,
4. Providing a variety of tools for the user to examine and change metadata,
5. Providing tools for the user to add metadata where none exists,
6. Providing tools that allow the user to work with standardized tag vocabularies (also known as ‘controlled vocabularies’),
7. Providing tools that allow the user to create and maintain custom metadata vocabularies,
8. Providing mechanisms for the user to make subsets of tag vocabularies to optimize the tagging process related to specific file sets,
9. Providing tools for the user to collaborate with other users during the creation of metadata vocabularies,
10. Providing mechanisms that integrate metadata with the files so the metadata is carried with the file throughout the workflow/lifecycle,
11. Providing tools that let the user create queries of the existing metadata in the fileset, and present the results,
12. Providing tools to allow the user to export the files that result from the search for processing outside the application, and
13. Providing vocabulary documentation, and metadata summary information documentation, to the user community for creation of third-party applications that establish critical mass for the tag vocabulary and encoding scheme.

In another embodiment, the present invention provides a methods for storing, and presenting metadata vocabularies which include the descriptions of tags so possible adopters will know the exact purpose of the tags in the tag vocabulary, and guidance for the creation of new tags to supplement the existing tags.

In another embodiment, the present invention provides guidance for the application of a specific tag in the broader context of the tag vocabulary.

A further understanding of the functional and advantageous aspects of the invention can be realized by reference to the following detailed description and drawings.

### BRIEF DESCRIPTION OF THE DRAWINGS

The embodiments of the present invention are described with reference to the attached figures, wherein:

FIG. 1 shows an exemplary operating environment for implementing the invention.

FIG. 2 shows a method in accordance with one embodiment of the present invention for associating metadata tags with a file.

FIG. 3 shows another method in accordance with one embodiment of the present invention for associating metadata tags with a file.

FIG. 4 shows a legend of node representations in subsequent drawings.

FIG. 5 shows the primary (top level) tag nodes in a tree representation of a set of metadata tags.

FIG. 6 shows the expansion of a primary tag node showing intermediate tag nodes.

FIG. 7 shows a further expansion of an intermediate tag node with corresponding leaf nodes.

FIG. 8 shows the tree structure after a leaf tag node has been selected.

FIG. 9 shows the expansion of a location-type primary tag node showing regional intermediate tag nodes.

FIG. 10 shows a further expansion of a location-type primary tag node showing leaf tag nodes and the suppression of unselected intermediate tag nodes.

FIG. 11 shows another expansion of a location-type primary tag node.

FIG. 12 shows yet another expansion of a location-type primary tag node.

FIG. 13 shows a further expansion of a location-type primary tag node.

FIG. 14 shows a further expansion of a location-type primary tag node.

FIG. 15 shows a further expansion of a location-type primary tag node.

FIG. 16 shows a tree representation of a superset of tag nodes (tagset) where a set of tag nodes for inclusion in the tag selection process is chosen by selecting specific tag nodes.

FIG. 17 shows a possible presentation format for tagset selection.

FIG. 18 shows a list of selected primary tag nodes to be saved for inclusion in a tagset.

FIG. 19 shows a user interface window for the selection of a specific tagset.

FIG. 20 shows a tree structure when multiple intermediate tags are selected by the user.

FIG. 21 shows the tree structure presented to the user after selecting multiple intermediate nodes, where a first intermediate node subset is presented.

FIG. 22 shows the tree structure presented to the user after selecting multiple intermediate nodes, where a second intermediate node subset is presented.

FIG. 23 shows the tree structure presented to the user after selecting multiple intermediate nodes, where multiple leaf nodes are selected.

FIG. 24 shows the tree structure presented to the user where a tag node had previously been applied to the file.

FIG. 25 shows the tree structure presented to the user where a first primary tag node in the tagset is initially presented.

FIG. 26 shows the tree structure where tag nodes selected remain expanded.

FIG. 27 shows another tree structure presented to the user where a tag node had previously been applied to the file.

FIG. 28 shows another tree structure presented to the user where a tag node had previously been applied to the file, where an intermediate node has been designated for inclusion in the tagset.

FIG. 29 shows another tree structure presented to the user where a tag node had previously been applied to the file, where an intermediate node has been designated for inclusion in the tagset, and the intermediate node is selected.

FIG. 30 shows a column representation in which icons provide information regarding the nodes selected in the tagset.

FIG. 31 shows a specific column representation in which intermediate tag nodes relating to a location-based primary tag node are displayed.

FIG. 32 shows a further expansion of the column representation.

FIG. 33 shows yet another expansion of the column representation.

FIG. 34 shows another expansion of the column representation in which leaf nodes are presented.

FIG. 35 shows an expansion of the column representation with an indication of which primary node is expanded.

FIG. 36 shows a further method in accordance with one embodiment of the present invention for associating metadata tags with a file.

FIG. 37 shows a tree representation of a large tag set (tag vocabulary).

FIG. 38 shows a button and tab representation in which the first primary tag node is expanded to show leaf nodes a buttons and intermediate tag nodes as additional tabs.

FIG. 39 shows the selection of an adjacent tab and the buttons belonging to the selected tab.

FIG. 40 shows the selection of a button.

FIG. 39 shows the selection of two buttons.

FIG. 42 shows the display as a user enters a first keystroke to create a new button.

FIG. 43 shows the display as a user enters an intermediate keystroke to create a new button.

FIG. 44 shows the display as a user enters a final keystroke to create a new button.

FIG. 45 shows the addition of a newly created button in the hierarchy of the tag set tree structure.

FIG. 46 shows the result of changing a button to a tab.

FIG. 47 shows an additional button for applying a tab as a tag.

FIG. 48 shows an additional button for skipping to the next tab in the tab series.

FIG. 49 shows a tagset in which only some leaf nodes have been selected for inclusion as buttons.

FIG. 50 shows a tab with buttons only corresponding to leaf nodes selected in a tagset.

FIG. 51 shows a tagset with upward arrows indicating that multiple buttons are to be included in a single tab by bypassing empty tabs.

FIG. 52 shows a tab in which multiple buttons have been included by bypassing empty tabs.

FIG. 53 shows a tagset with arrows indicating that selected tabs first appear as buttons (i.e. buttontabs).

FIG. 54 shows two buttontabs in a pane.

FIG. 55 shows the selection of a buttontab.

FIG. 56 shows the result of the selection of a buttontab, where the buttontab is subsequently displayed as a tab.

FIG. 57 shows the selection of two buttontab

FIG. 58 shows the result of the selection of two buttontabs, where the buttontabs are subsequently displayed as two tabs.

FIG. 59 shows a user interface for rendering multiple files and supporting multiple file selection.

FIG. 60 shows a user interface for rendering files and displaying tabs and buttons according to the invention.

FIG. 61 shows a user interface where a single file is selected and rendered.

FIG. 62 shows a user interface where tag nodes are selected and displayed over a rendered image.

### DETAILED DESCRIPTION OF THE INVENTION

Generally speaking, the systems described herein are directed to a computer readable medium encoded with computer-executable instructions which, when executed by a processor, perform a method of associating a file with one or more metadata tags. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a computer readable medium encoded with computer-executable instructions which, when executed by a processor, perform a method of associating a file with one or more metadata tags.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the term “tag node” means a metadata tag existing in a hierarchy structure.

As used herein, the term “primary tag node” means a tag node residing in the first subset of tag nodes within a metadata hierarchy.

As used herein, the term “intermediate tag node” means a tag node residing in the second or deeper subset of tag nodes within a metadata hierarchy, with further dependent tag nodes.

As used herein, the term “leaf tag node” means a terminal tag node residing in a metadata hierarchy, with no further dependent tag nodes.

As used herein, the acronym “TAP” means “Tag Assignment Procedure” is a method of applying metadata tags to a file.

As used herein, the term “TAP mode” refers to a computer user interface that optimizes the process of assigning and associating metadata with files in which the user interface guides the user through the process of tag assignment by presenting one subset of tag nodes existing in a hierarchy at a time.

As used herein, the term “file” means any computer-readable file including, but not limited to, digital photographs, digitized analog photos, music files, video clips, text documents, interactive programs, web pages, word processing documents, computer assisted design files, blueprints, flowcharts, invoices, database reports, database records, video game assets, sound samples, transaction log files, electronic documents, files which simply name other objects, and the like.

As used herein, the term “metadata tag” or “tag” means any descriptive or identifying information in computer-processable form that is associated with particular file. For example, metadata items may include but are not limited to title information, artist information, program content information (such as starting and ending times and dates for broadcast program content), expiration date information, hyperlinks to websites, file size information, format information, photographs, graphics, descriptive text, and the like.

Furthermore, data files can themselves be metadata for a real world object, for example, the photograph of a collectible (the characteristics applied to the photo do not relate to the photo itself, but to the subject of the photo) or the sound of a musical instrument (the sound file is representative of the musical instrument, and is not itself a valuable data file). All of these types of metadata require management and, to date, no prior art comprehensive tool set exists that supports these diverse metadata applications.

Generally speaking, files will have metadata tags that are relevant to a number of characteristics of the file and the overall file set, including, but not limited to, the file's technical aspects (format, bytes used, date of creation), the workflow in which the file participates (creator, owner, publisher, date of publication, copyright information, etc) and the subject matter of the file (the nature of the sound of an audio file, be it music or a sound-effect, the subject of a photograph or video clip, the abstract of a lengthy text document, excerpted particulars of invoices or other data-interchange format files).

The present invention provides an improved method of classifying an item based on selecting one or more descriptive tags from a structured set of tags. The structured set of tags is provided in a hierarchal format. Unlike prior art classification methods, the present invention provides a method that is more user-friendly by only presenting, at a given time during the classification process, a limited number of tag choices that correspond to a given level within the hierarchy. The method also advantageously improves the user experience by guiding the user through a progression of such choices.

In a preferred embodiment, the invention provides a method for applying metadata tags to a file, including, but not limited to, media files such as digital photos, music, and videos. The invention provides several improvements over prior art metadata methods, including a reduction in the precision required for most of the clicks in a tree or other tag representation, and a reduction in the total number of clicks required to tag a file.

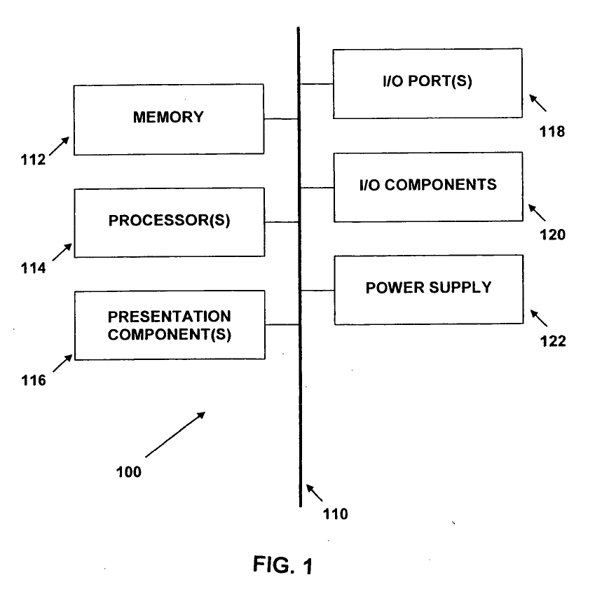

An exemplary operating environment for implementing the present invention is described below with reference to FIG. 1, which generally shows a computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

In certain preferred embodiments of the invention, a computing device executes computer-executable instructions, which represent any signal processing methods or stored instructions. Generally, computer-executable instructions are implemented as software components according to well-known practices for component-based software development, and encoded in computer-readable media (such as computer-readable media). Computer programs may be combined or distributed in various ways. Computer-executable instructions, however, are not limited to implementation by any specific embodiments of computer programs, and in other instances may be implemented by, or executed in, hardware, software, firmware, or any combination thereof.

Generally speaking, the present invention may be implemented on a computing device such as the device shown in FIG. 1, which is employed to present a user interface to a user. A user interface, as used herein, is a physical or logical element that defines the way a user interacts with a particular application or device, such as client-side operating environment. Generally, presentation tools are used to receive input from, or provide output to, a user. An example of a physical presentation tool is a display such as a monitor device. An example of a logical presentation tool is a data organization technique (such as a window, a menu, or a layout thereof). Controls facilitate the receipt of input from a user. An example of a physical control is an input device such as a remote control, a display, a mouse, a pen, a stylus, a microphone, a keyboard, a trackball, or a scanning device. An example of a logical control is a data organization technique via which a user may issue commands. It will be appreciated that the same physical device or logical construct may function as an interface for both inputs to, and outputs from, a user.

Computer-readable media, as described herein, represents any number and combination of local or remote devices, in any form, now known or later developed, capable of recording, storing, or transmitting computer-readable data, such as computer-executable instructions or data sets. In particular, computer-readable media may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. Computer-readable media may also include transmission media and data associated therewith. Examples of transmission media/data include, but are not limited to, data embodied in any form of wireline or wireless transmission, such as packetized or non-packetized data carried by a modulated carrier signal.

As noted above, the invention is described as implemented with computer or machine-useable instructions, including computer-executable instructions such as program modules, being executed by a computer or other machine, such as personal electronic devices. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. Personal electronic devices include any portable or non-portable electronic devices that are configured to provide the management, collection, assignment, or storage of metadata and/or files. Examples of personal electronic devices include but are not limited to mobile phones, personal digital assistants, personal computers, media players, televisions, set-top boxes, hard-drive storage devices, video cameras, DVD players, cable modems, local media gateways, and devices temporarily or permanently mounted in transportation equipment such as planes, or trains, or wheeled vehicles.

The preceding operating environment for implementing the present invention is provided merely as an example. The invention may also be practiced in distributed computing environments where tasks are performed by remote-processing devices that are linked through a communications network. For example, the invention may be enabled in a client-server architecture, or may be provided in a hosted or in a software-as-a-service model.

The invention may be implemented with a wide range of computing devices, environments or systems that communicate over a network. The invention may be implemented with devices in communication other devices, which may include but are not limited to personal digital devices, remote servers, computers or other processing devices. Communication protocols or techniques may be employed that include but are not limited to: peer-to-peer communication tools and techniques; Ethernet; IP; Wireless Fidelity (“WiFi”); Bluetooth; General Packet Radio Service (“GPRS”); Evolution Data Only (“EV-DO”); Data Over Cable Service Interface Specification (“DOCSIS®”); proprietary techniques or protocols; datacasting; High Speed Downlink Packet Access (“HSDPA”); Universal Mobile Telecommunication System (“UMTS”); Enhanced Data rates for Global Evolution (“EDGE”); Digital Video Broadcasting-Handheld (“DVB-H”); and digital audio broadcasting (“DAB”).

In a preferred embodiment of the invention, the user is guided through a tagging process. A file to be tagged with metadata tags is presented to the user or selected by the user in a user interface. One or more metadata tags may then be applied to the file according to the following method.

As described above, the metadata tags reside in a hierarchal structured set. The set comprises primary tag nodes, which form the first subset of tag nodes within the hierarchal structure, intermediate nodes, which are all non-primary nodes to which additional tag nodes below, and leaf tag nodes, that terminate the hierarchal structure. Unlike prior art metadata tagging methods and user interfaces, the present invention does not simply present the entire hierarchal structure to the user, but instead assists the user in the selection of appropriate metadata tags through a guided process. In a preferred embodiment, one subset of tag nodes is active at any given time during the tagging process.

In a preferred embodiment of the invention, a user interface displays to the user a first subset of primary tag nodes, which generally represent high-level categories. The user selects a primary node to activate, which causes the user interface to display the subset of tag nodes that are in the next level of the hierarchal structure; in other words, the selection of the primary node causes the user interface to display the tag nodes belonging to the primary tag node. The tag nodes may include intermediate tag nodes, leaf tag nodes, or a combination of the two. The user selects an intermediate tag node, which in turn causes the next level of tag nodes to be displayed, i.e. the tag nodes belonging to the intermediate tag node are displayed.

According to a preferred method of the invention, deeper tag node subsets within the hierarchal structure of the set of tabs are sequentially presented to the user until a leaf tag node is selected. Upon the selection of an appropriate leaf tag node, the subset of primary tag nodes is again presented to the user, and the process is repeated for the additional primary tag nodes.

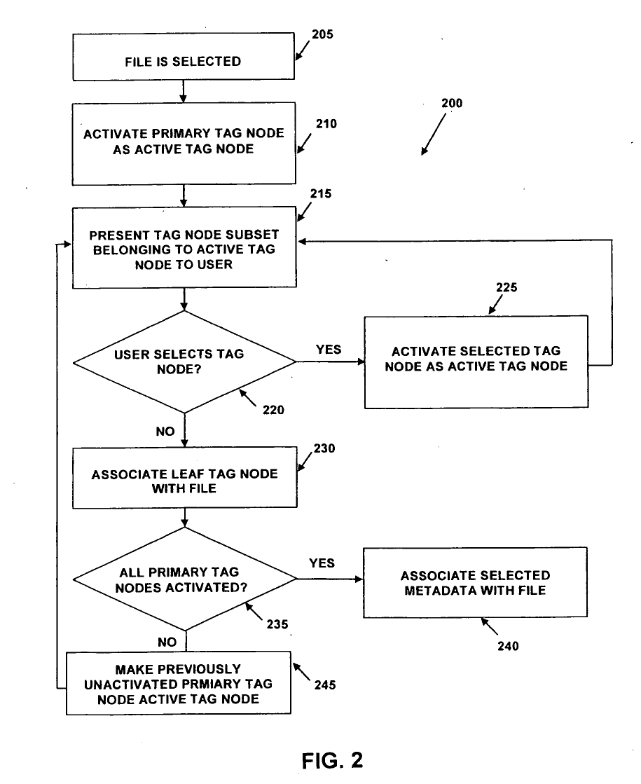

The above method is shown in FIG. 2 at 200 as a flow chart. In a first step 205 of the illustrated method, a file is selected to be associated with one or more metadata tags. Step 205, and further steps in which the method includes the interaction with a user, are preferably executed via a user interface. The file may be selected by the user, or may be provided by an automated search of a computing environment resulting in a list of candidate files. A set of tags, provided in a hierarchal format, is used for the association of the file with metadata. The set of tags, arranged as tag nodes within the hierarchal structure, may be a predefined set of tags, or the set may be imported from another user of third party source. The set may further comprise a combination of user-defined tag nodes and third-party tag nodes. The tag set may be loaded from a computer readable media that can include, but is not limited to, a user's hard drive, a portable media source, or a networked source such as a remote server. The tag set is preferably provided and stored as a data structure preserving the hierarchal format of the tag nodes contained therein.

As shown in step 210 of the method, an active tag node is first identified as a primary tag nodes. This primary node is a node from the first level of nodes in a hierarchal format, eg. the first column of tag nodes in a tree representation. Subsequently, in step 215, the tag nodes subset belonging to the active tag node are presented to the user for selection. The primary tag node subset likely does not contain leaf tag nodes and is instead made up of intermediate nodes having tag node subsets. In step 220, the user selects an intermediate tag node (assuming no leaf tag nodes are present) and in step 225, the tag node subset belonging to the selected intermediate tag node becomes the active tag node subset. Step 215 is subsequently repeated, this time displaying the tag node subset belonging to the new active tag node.

If a leaf tag node belongs to the new active tag node and the user selects the leaf tag node in step 220, then the selected tag node is associated with the file in step 230, and then if in step 235 there are additional primary tag nodes that have not yet been identified, then a previously unactivated primary tag node is activated as the active tag node in step 245, and step 215 is repeated. If, on the other had, if the active tag node subset had contained an intermediate tag node that was selected by the user in step 220, then as before, the tag node subset belonging to the selected intermediate tag node would become the active tag node subset, and step 215 would be repeated, displaying the new active tag node subset.

The above process continues until it is determined in step 235 that all primary tag nodes have been activated, i.e. the user has had the opportunity to tag the file with tag nodes descendant to all primary tag nodes. The collection of tag nodes associated by the user by the selection of leaf tag nodes (if any) is subsequently associated with the selected file in step 240. In a preferred embodiment, the metadata is embedded in the file.

In a preferred embodiment, the user may terminate the tag selection process at any time during the aforementioned steps, for example, by the selection or actuation of a user interface button or context menu item.

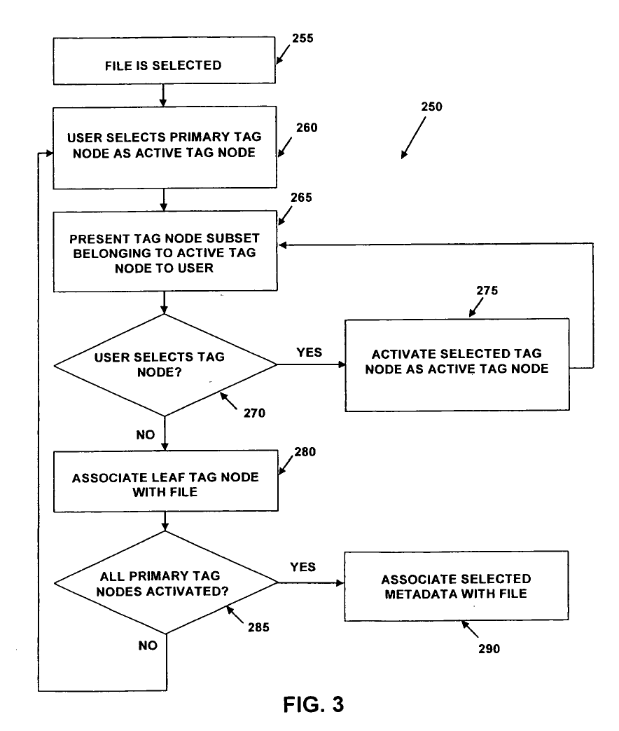

FIG. 3 shows another preferred embodiment of the method generally at 250. A file is selected in step 255. In step 260 of the method, a primary tag node is activated by the user as the active tag node. In step 265, the tag node subset belonging to the active tag node is presented to the user for selection. The tag node subset of a primary tag node may contain intermediate tag nodes and/or leaf tag nodes. In step 270, if the user selects an intermediate tag node and in step 275, the tag node subset belonging to the selected intermediate tag node becomes the active tag node subset, and step 265 is repeated, this time displaying the tag node subset belonging to the new active tag node. If a leaf tag node is selected in step 270, then the selected tag node is associated with the file in step 280, and if all primary tag nodes have not yet been activated in step 285, the user again selects a primary tag node as the active tag node in step 260.

As in FIG. 2, the above process continues until it is determined in step 285 that all primary tag nodes have been activated, i.e. the user has had the opportunity to tag the file with tag nodes descendant to all primary tag nodes. The collection of tag nodes associated by the user by the selection of leaf tag nodes (if any) is subsequently associated with the selected file in step 290.

The preceding embodiments, and variations thereof, are henceforth described with reference to an embodiment in which a user selects metadata tags via a user interface that displays tag nodes within a tree structure. Those skilled in the art will readily appreciate that this specific embodiment of the methods of the invention is a non-limiting example that can by adapted to other related methods and presentation formats. To further illustrate this compatibility and generalization of the invention to other methods, further examples are provided later sections of this disclosure in which the tag nodes are presented in column display format and in a multi-pane window format with selectable tabs and buttons.

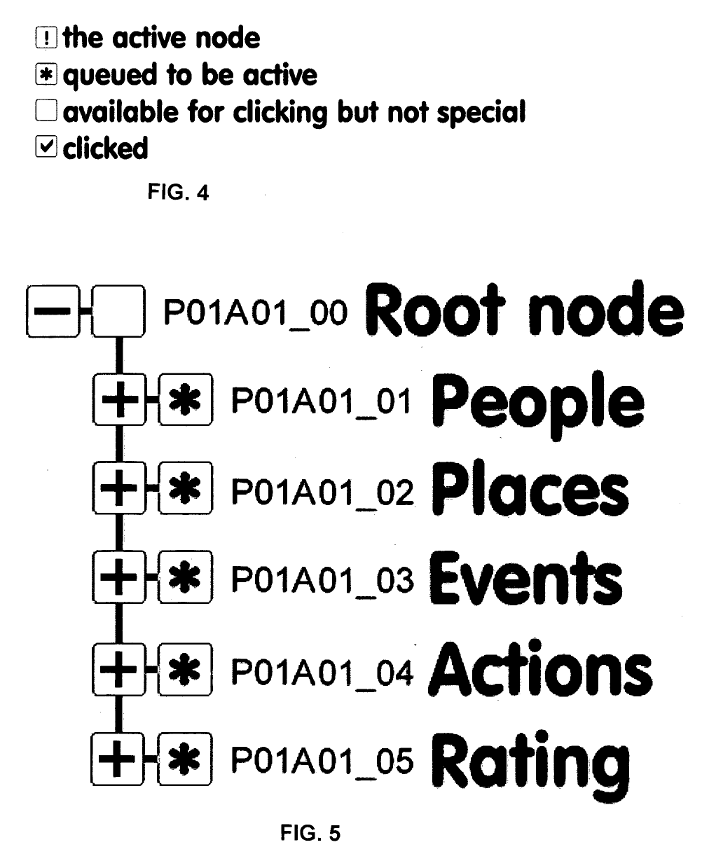

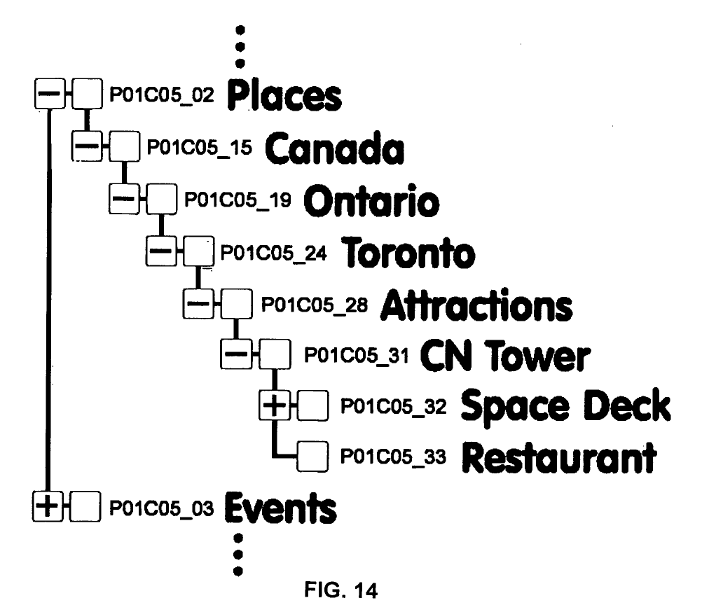

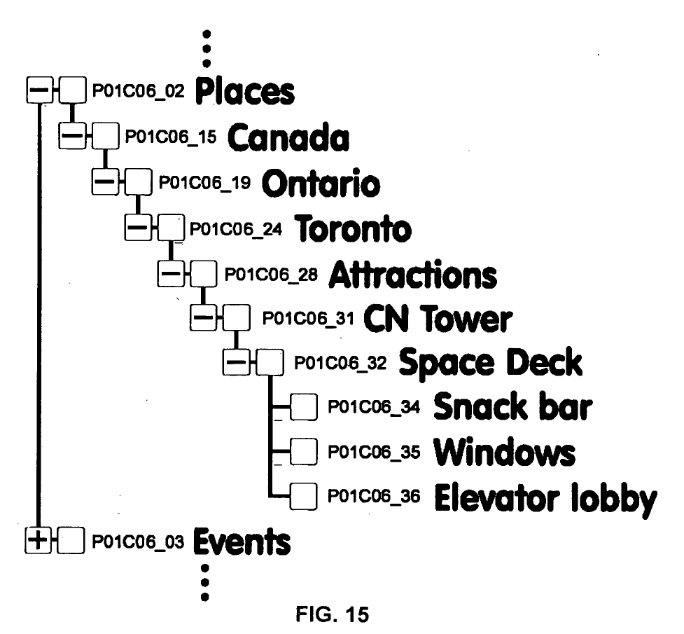

The following example provides an embodiment in which a method of the invention is adapted to a user interface in which the hierarchal tag structure is presented in a tree format. FIG. 4 provides a legend describing the icons used to represent tree tag nodes. With reference to the FIGS. 4-35, for this example it is assumed that the user is tagging photo files, and the top level nodes of a metadata keyword tree are “People”, “Places”, “Events”, “Actions” and “Rating”, as shown.

When a new image is focused for metadata application, the tree containing the metadata library gets “reset”, by collapsing all the nodes, except for the top level node of the tree. Additionally, the top-level nodes exposed are each queued to be visited, as described below. Those nodes are marked with a ‘*’ symbol in the figures, as an indication that the user can be kept informed of the queued nodes. Thus the 5 above-mentioned nodes are visible, and marked with a ‘*’.

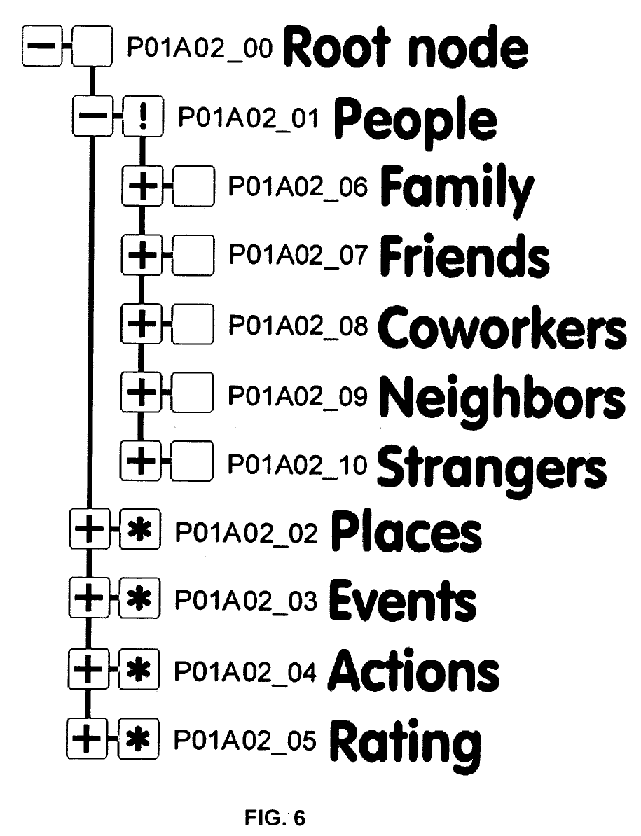

Immediately thereafter, with no user intervention, the first top level node (the “P01A01_01 People” node) (which is the first queued node) is then automatically expanded, with its sub nodes displayed. See FIG. 6. In this example, the sub-nodes are “P01A02_06 Family”, “P01A02_07 Friends”, “P01A02_08 Coworkers”, “P01A02_09 Neighbors”, and “P01A02_10 Strangers”.

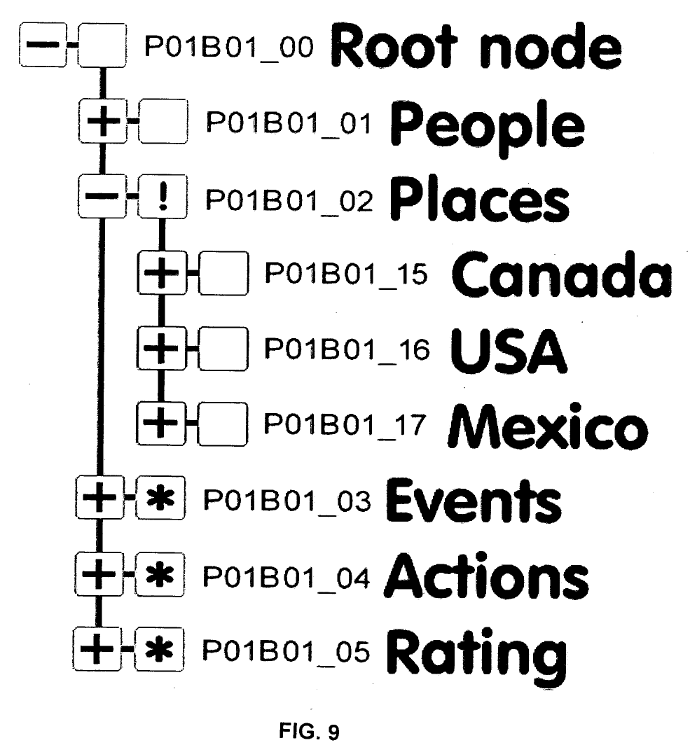

The user now looks at the photo, and decides which people are present and worthy of being encoded into the metadata of the photo. If the user chooses to not tag any people, either because there are no people in the photo or the user simply chooses not to tag them, the user should click on the next top level tree node, in this case, “P01A02_02 Places”. That causes the “P01A02_01 People” node to collapse and the “P01A02_02 Places” node to expand. See FIG. 9. The tagging opportunity is again presented, with the activated node being “P01B01_02 Places” instead of “P01B01_01 People”.

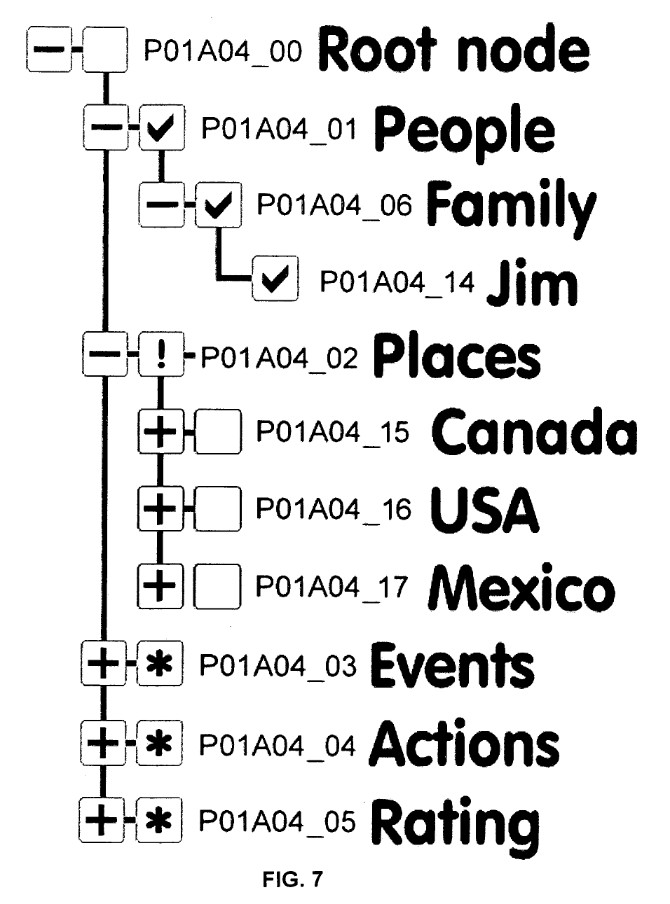

The more interesting case is where, again with reference to FIG. 6, the user sees a person in the photo, perhaps a family member, and decides to add a tag for that person. In this case, due to being in “TAP mode”, the tree, being specially primed to be responsive to clicks on the nodes, reacts to the user clicking on the “P01A03_06 Family” node by hiding the other nodes at that level, (nodes shown in FIG. 6: namely, “P01A02_07 Friends”, “P01A02_08 Coworkers”, “P01A02_09 neighbors”, “P01A02_10 strangers”) and leaving the “P01A03_06 Family” node showing, and expanding it, showing its sub-nodes. The resulting appearance can be seen in FIG. 7.

In this example the nodes are “P01A03_11 Mom”, “P01A03_12 Dad”, and “P01A03_13 Me”, and “P01A03_14 Jim”, (for instance,) the tagger's brother.

By pressing one of those nodes, for example, “P01A03_14 Jim”, the tagger then causes the following automatic procedure to be carried out:

The node pressed being a leaf node (it has no contained subnodes) results in that node, and its' parent nodes, being embedded into the metadata thus: people/family/jim.

The “P01A03_01 People” node is now collapsed and all its subnodes are restored to the tree, as before (but hidden by the fact that the “P01A03_01 People” node is now collapsed). The “P01A03_02 Places” node is expanded, resulting in the tree being displayed as in FIG. 9.

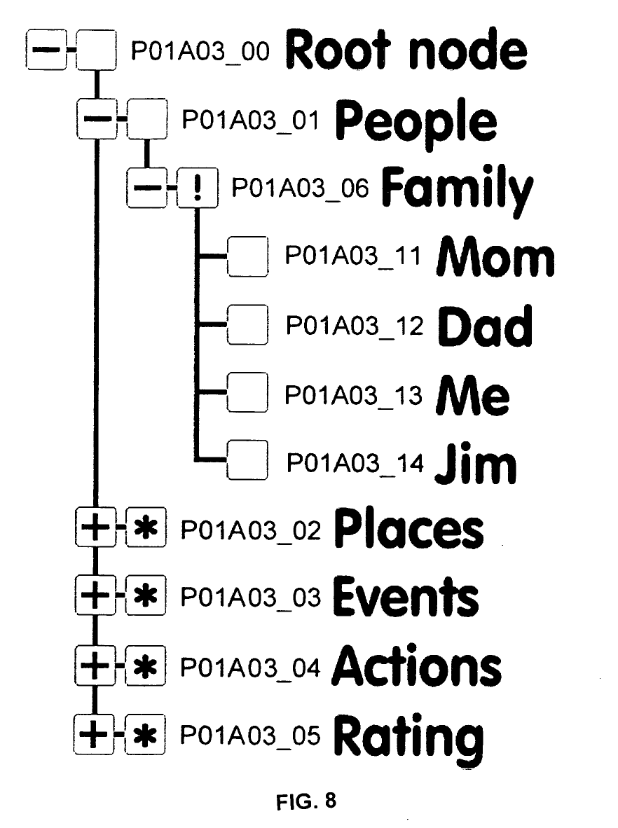

Another option is that the tag that was applied remains visible without its siblings, as in FIG. 8. In this case, the icons on the node “P01A04_14 Jim”' and its parents are modified in colour, or the icons are changed, to indicate that this path of nested keywords is now present in the metadata for the selected file(s). The optional display of existing and freshly applied metadata is shown, in the following continuation of this example.

As a result, by clicking “P01A04_06 Family” and “P01A04_14 Jim”, 3 pieces of metadata have been embedded, and the focus is ready for the clicking of a relevant node in the “Places” branch of the tree. The above description encapsulates the main benefit of the TAP mode interface. In the following paragraphs the generalizations and expansions on this procedure are described, for cases where the user needs to supply or edit additional metadata.

The text is a larger target and more intuitive than an icon, since the user knows exactly which choice he or she wants to make and clicks directly on the text word. Picture icons could also be used, in tree form, to provide an even larger target for clicking, an embodiment that would be useful for making the tagging process accessible to children.

The user's attention need not leave the text or image representing the keyword they wish to apply, as would be required to click a checkbox or other user interface component distinct from the text itself: the user need just move the mouse to where their eyes are already looking.

In general, when tagging photos, the user would assign only a single linear branch of metadata for “P01A01_02 Places”. In a scenario where the user has clicked “P01B01_15 Canada”, “P01C01_19 Ontario”, “P01C02_24 Toronto”, “P01C03_28 Attractions”, “P01C04_31 CN Tower”, and “P01C05_32 Space Deck” in turn as shown in the Figure series 9 and 10 to P01C05, “P01C05_32 Space Deck” may contain sub nodes, but the user does not want to be more specific, so rather than clicking the subnodes of “P01C05_32 Space Deck” shown in Figure P01C06, namely “P01C06_34 Snack bar”, “P01C06_35 Windows”, “P01C06_36 Elevator lobby”, he clicks “P01C05_32 Space Deck” again, causing the app to recognize this as the final node in the series. He might have alternatively double-clicked the “P01C05_32 Space Deck” node to indicate he wanted it embedded without embedding any more subnodes, or simply click another queued node, later on in the progression, designated by a ‘*’ icon in these examples, such as “P01C06_03 Events”.

Then the parent nodes of “P01C05_32 Space Deck” will be collapsed, and the “P01C06_03 Events” node at top level will be expanded.

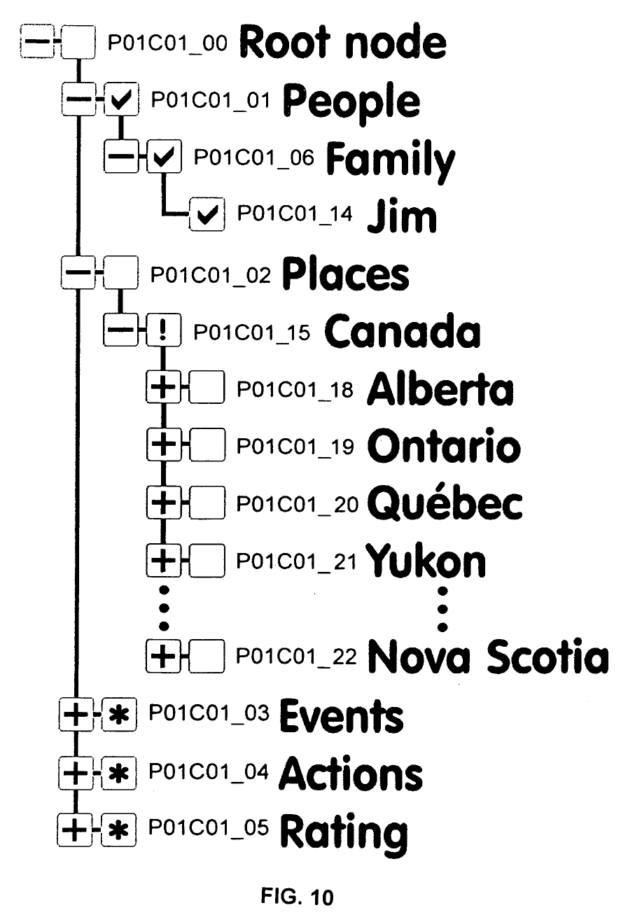

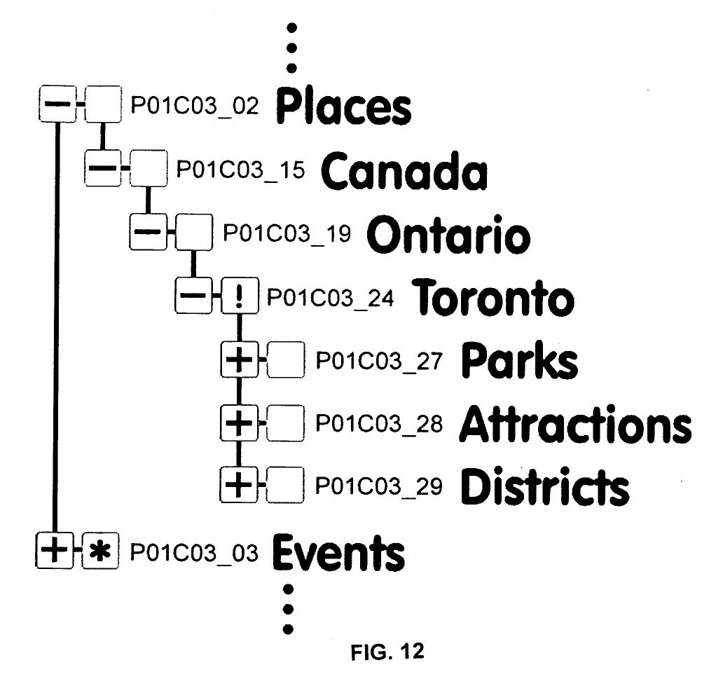

It is important to note that as in FIG. 8 on “P01A04_02 Places”, there was shown “P01A04_15 Canada”, “P01A04_16 USA”, and “P01A04_17 Mexico”. By clicking “P01A04_15 Canada”, both the “P01A04_16 USA” and “P01A04_17 Mexico” nodes are hidden, and the tree is rendered so that under “P01A04_02 Places”, there is only one node, “P01A04_15 Canada”, and then under “P01A04_15 Canada”, the 10 provinces and 3 territories are shown. When clicking on “P01C01_19 Ontario” as shown in FIG. 10, the other provinces disappear and the “P01C01_19 Ontario” node is expanded as shown in 11, to show “P01C02_23 Hamilton”, “P01C02_24 Toronto”, “P01C02_25 Ottawa” and “P01C02_26 other”. By clicking on “P01C02_24 Toronto”, the three sibling nodes city nodes “P01C02_23 Hamilton”, “P01C02_25 Ottawa” and “P01C02_26 other” are hidden and, as shown in FIG. 12, the nodes “P01C03_27 Parks”, “P01C03_28 Attractions”, and “P01C03_29 Districts” are shown.

The important feature to be noted in hiding intervening nodes is the dual benefit of simplifying the user interface and bringing nodes closer to the mouse pointer the above-mentioned procedure is that once a decision is made, the distracting options that were not chosen are hidden from view.

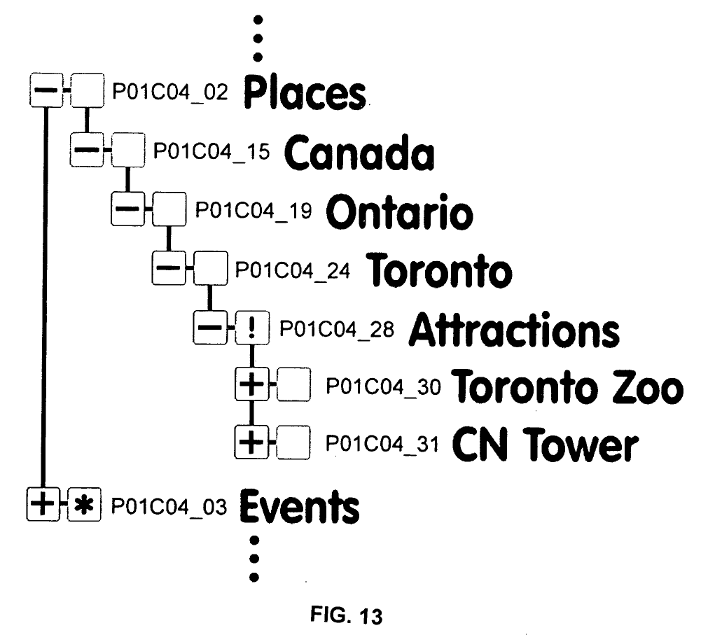

In order to revisit the other parts of Toronto after clicking on “P01C03_28 Attractions”, the user would simply click on “P01C03_24 Toronto” again. This would hide the individual attractions and instead show the parts of Toronto again. This would cause the tree, as pictured in FIG. 13 to revert to the appearance of FIG. 12 again.

Thus the user has control of what in the tree is visible, but in the context not of exploring the tree, but of applying metadata.

Additional capabilities related to editing metadata may readily be incorporated into the TAP. The nodes representing already-embedded metadata are visible in the tree, and by clicking them the user can direct that they be removed from the file. In the case of a multiselection, the user may have control over whether all selected files' metadata are shown or just the metadata related to a particular file considered to be the focused file.

The icon on the nodes already in the metadata may reflect the “not-present”, “focus file and some files” or “all files” mode with appropriately chosen icons and supporting material to educate the user how to recognize and distinguish between those icons. Tooltips can also be provided which allow the user to determine the status and properties of a node already present in the metadata, to augment the information provided by the icons, and jog the user's memory if he forgets the meanings of the icons.

In addition to the above tag assignment procedure implementation, the present invention provides an additional method and user interface for improving the ergonomics of a hierarchal-based control for applying metadata.

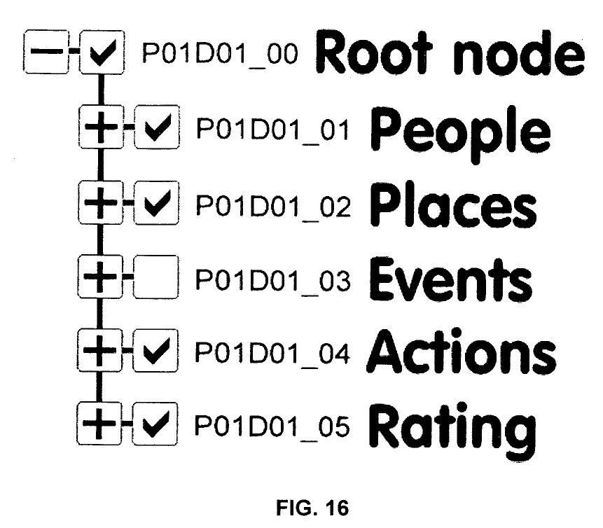

First, by implementation of a mode activated by a toolbar button or menu command, or by use of a context menu option, the user can change the function of clicks on nodes to be in the nature of configuration, rather than tagging. This is hereafter referred to as “Tagset Mode”. See FIG. 16. In the case of FIG. 16, checkboxes on the nodes indicate that when in “TAP mode” the checked node will be shown. Nodes not having their checkbox checked will show in configuration mode, and perhaps (at user option) when found in existing metadata in the selected files, but will not be shown in the tree, and will not be expanded and visited during the TAP.

In “Tagset Mode”, there are checkboxes on all the nodes of the tree. By manipulation of the checkboxes the user is designating which nodes to show when using “TAP Mode”. Appropriate use of three-state checkboxes can be used to additionally inform the user that a certain collapsed node has descendant nodes some of which are checked and some of which are unchecked. Different industry standard methods can be used to indicate the three choices, including special icons, a gray checkmark or perhaps a shading of the checkbox. These choices are familiar to a programmer of ordinary skill in user interface development.

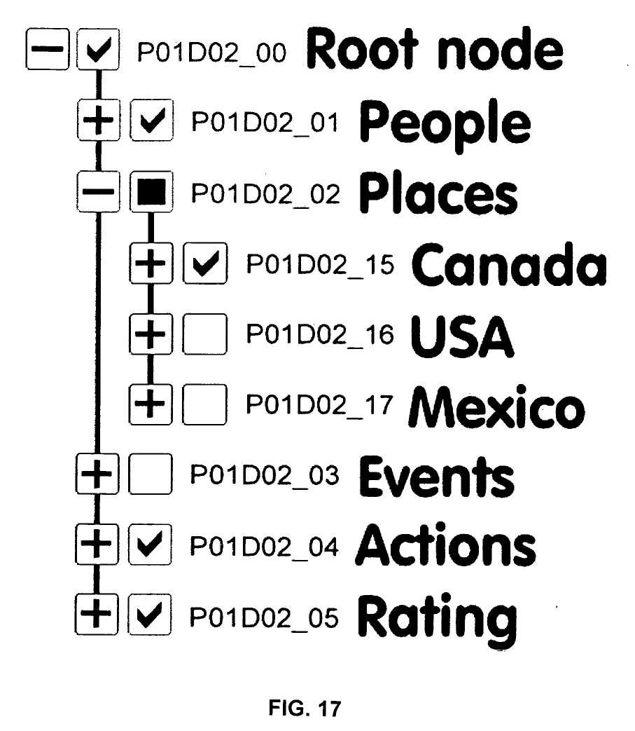

It is possible and desirable through the iconic symbols on the tree nodes, when in “TAP mode” to be able to indicate if other choices have thus been suppressed, and to additionally offer a context menu option to re-display the checkboxes and the missing nodes so that the tree can be reconfigured. This can be achieved by colouring the text on the parent node, or by modifying the icon on the parent node. For example, the list of child nodes can be compared for the nodes of “P01B01_02 Places” in FIG. 9 and those of “P01C01_02 Places” in FIG. 10. Note that while in FIG. 9 two siblings to the node “P01B01_15 Canada” are shown (namely “P01B01_16 Mexico” and “P01B01_17 USA”) they have been suppressed from display under the “P01C01_02 Places” node. Note that in FIG. 17 the checkbox for the node “P01D02_02 Places” is shown neither checked nor unchecked. The result of a mouse click on the “P01D02_02 Places” checkbox is implementation dependent. It could be configured to activate the checkbox on all the direct children, or perhaps recursively check all the descendant nodes in all descendant branches, or to uncheck children or descendants that are already checked. For example, clicking on a partly populated checkbox can result in unchecking of all the checked child nodes. An undo capability allows the user to reverse the effect of the checkbox operation, in case it was not as intended.

It is important to note that while in “Tagset mode”, the tree allows multiple branches to be expanded, at user option, through use of the + and − symbols on the nodes. Use of these user interface components in tree controls is familiar to all but the most novice computer users, and the extra effort required to interact with these tree-expand and tree-collapse user interface elements is only needed in the “Tagset Mode” configuration process, not the “TAP mode”, where most of the time is spent and most of the use of the tree is made.

It's also advantageous to save several different configurations of the checkboxes, for use in different kinds of file tagging operations. For instance, if tagging photos of a wedding you need different top-level choices than for photos of a sporting event. Having all tags visible, for instance, under the “Actions” or “Events” node just adds to distraction without aiding the user in selecting the appropriate tag. So by allowing the user to suppress display of certain nodes in the tree based on knowledge of the general subject matter in the file set, it's possible to simplify the visual appearance of the tree and improve the efficiency and lower the effort required to apply tags.

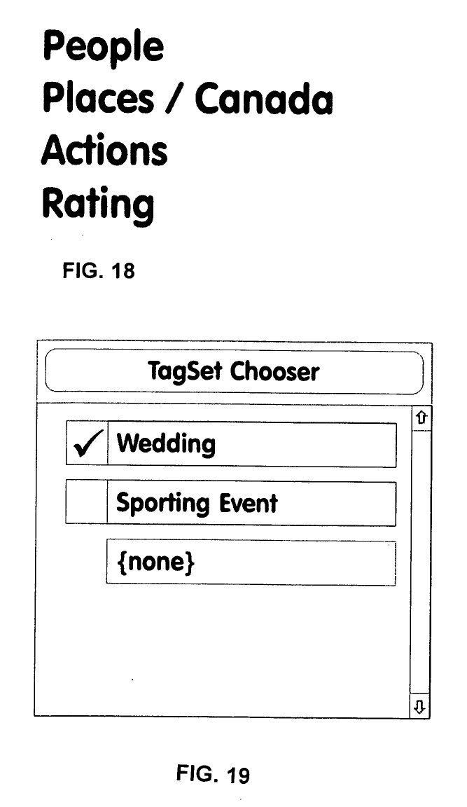

To save the configuration of checkboxes in the tree at any time, it would suffice to name the parent nodes in a text based list, and mention only those nodes which are checked off fully. There's no need to name the sub-nodes which are also checked off, but it's an option available to the programmer. See FIG. 18 for an example of the file contents to save a configuration.

The selected subset of the tags in the TAP interface is henceforth referred to as a ‘tagset’, and this list can be saved to an external file. Optionally, the settings could be stored in one large file (similar to an .ini file in Windows, having distinct tagset contents demarcated by ‘titles’ of sorts) or still as another alternative, saved to the Microsoft Windows registry.

There are additional features for simplifying this process, such as an additional user interface for selecting tagets, (an example is provided in FIG. 19, described below), and toolbar buttons which simplify management of the tagsets. However, for a modification or retrofit of a tool such as Windows Photo Gallery (included with some versions of the Windows Vista operating system), these improvements are not essential for the realization of the major advantages of the TAP.

Further description of the capabilities of the tagset chooser can serve to make the capabilities and function of the tagset chooser clear, in relation to applicability to trees, even to a programmer unfamiliar with the TAP interface, so it will be described in detail here.

The tagset chooser pane can be provided an area having buttons labeled with the names of saved tagsets, and provisions for adding a new tagsets, or saving the existing configuration of checkboxes into a new tagset. FIG. 19 provides a view of a possible implementation of the tagset chooser.

The tagset chooser offers the user the ability to save and restore configurations of checkboxes in the main tree, based on previous decisions about which ones should be shown for different events such as the example above, “Sporting Events” and “Weddings”. In the process of saving a configuration the user can be prompted to supply a name for the configuration and a filename for storing it.

One additional feature that is very valuable in the tagset chooser is the ability to select more than one tagset button at once. (for example, by control-clicking the subsequent buttons. A non-control click of a non-pressed button may unclicks the existing buttons and clicks the new button).

By clicking to activate more than one tagset at a time, a ‘composite tagset’ is created. In this way, the user can make many very small tagsets and activate multiple tagsets to create task-specific composite tagsets from smaller, easier-to-manage tagsets.

Another option for implementation of multiple tagset selection is to make a click on a single tagset button a simple toggle for that specific tagset. To clear all tagsets, an “unpress all” button could be provided either in the tagset chooser list itself (an appropriate button caption might be “{none}” for this unchecking button, as shown in FIG. 19), or separately as a toolbar button or context menu item. This alleviates the requirement to control-click additional buttons, further reducing the need to interact with the keyboard while tagging and configuring.

By including additional tagsets using procedures as the above methods describe, the effect is to bring in additional checkmarks into the tree. The result is the logical ‘or’ of all the checkboxes. The union of all the sets of checked nodes is used in the tree.

The tree now configured for use in “TAP mode”, the discussion returns to TAP mode operation. Another requirement when tagging structured metadata is that in some cases, more than one sub-branch of the tree needs to be visited and used.

Consider now the example where a photo depicts a coworker and a relative. In FIG. 6, the user might desire to tag the name of the coworker and the relative. By use of the control key, held during the mouse-click on the node, the result can achieved with a minimum of additional operations. The control key is held while all the parallel node choices are pressed, then released once this is done. The tree does not auto-expand while the control key is being pressed, but the icons on the nodes are changed to indicate that they are queued (marked with a ‘*’) to become active, or, if leaf nodes, that they have been successfully selected.

On release of control, the first (oldest) control clicked node is expanded (because it will be the next queued node). However, a difference from the standard TAP described above is that the other control-clicked nodes are not hidden in the tree, but remain as collapsed siblings to the expanded node. This process can be repeated at lower levels, resulting in a tree with some partially populated nodes and some top level nodes still fully collapsed.

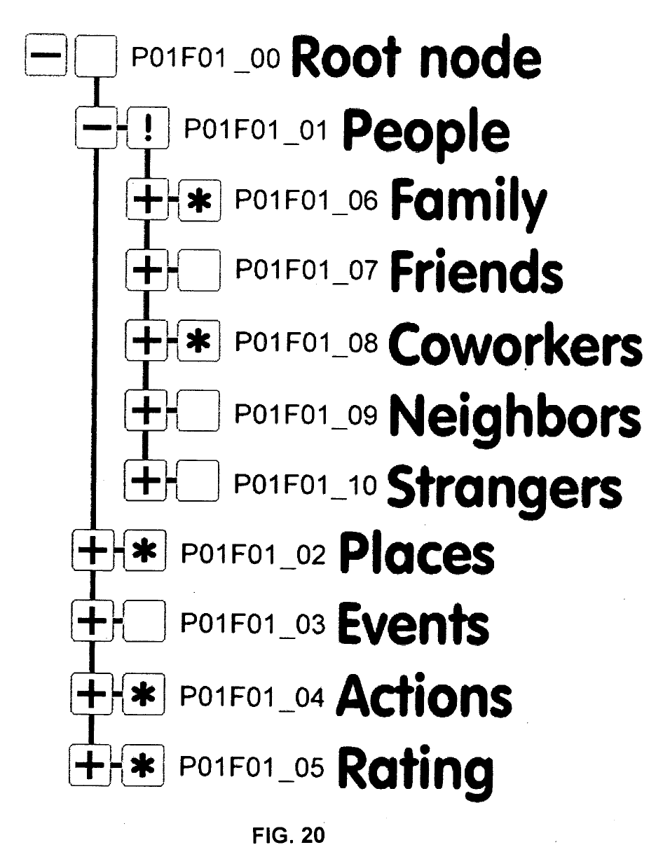

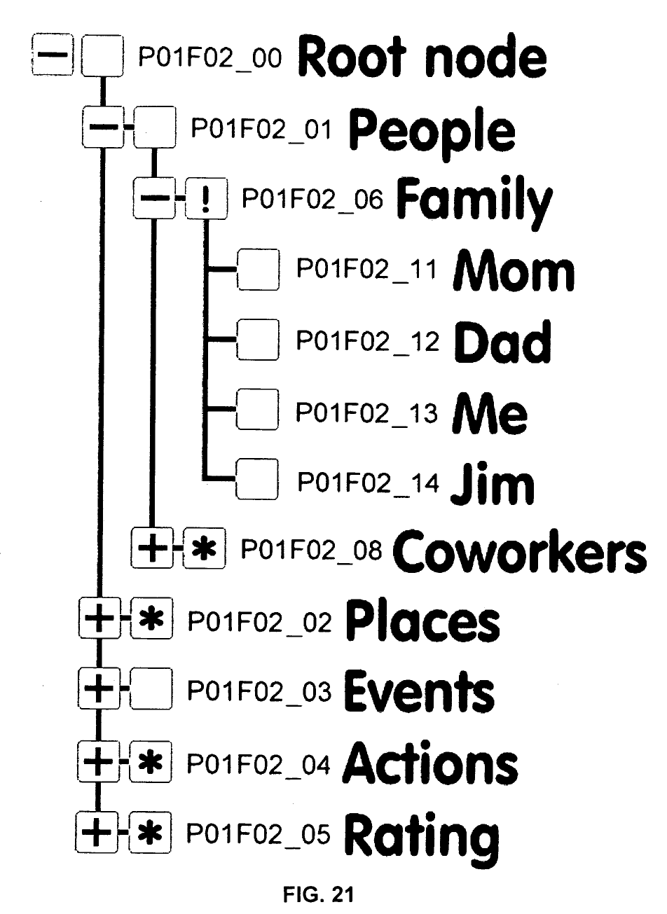

With reference to FIG. 6, in the TAP the user control-clicks each of the nodes “P01A02_06 Family” and “P01A02_08 Coworkers”. The requirement is that the control key should continue to be held down from the point before the first button is clicked until after the second button is clicked. Control-click of a tree node will cause its icon to change indicating it is queued for expansion (marked with a ‘*’). The result of pressing and holding control, and then clicking “P01A02_06 Family” and “P01A02_08 Coworkers”, will be that the icons on “P01A02_06 Family” and “P01A02_08 Coworkers” nodes will change to indicate that they have been pressed. In FIG. 20 we see the tree as it appears just after “P01F01_08 Coworkers” has been pressed. FIG. 21 shows the tree after the control key is released. The user now has the option of clicking one or more child nodes of the “P01F02_06 Family” node. The same principle applies. If the photo shows, for instance, mom, dad, and a coworker named Fred, then the process is to press and hold the control key, click “P01F02_11 Mom”, then while still holding the control key pressed, click “P01F02_12 Dad”, then release the control key.

When the control key is released, because none of the pressed nodes had sub-nodes, their branches are finished. The next node queued for inclusion in the TAP is activated. The parent of “P01F02_11 Mom” and “P01F02_12 Dad” was “P01F02_06 Family”. “P01F02_06 Family” has a sibling included in the TAP further down in the tree, “P01F02_08 Coworkers”, which gets activated.

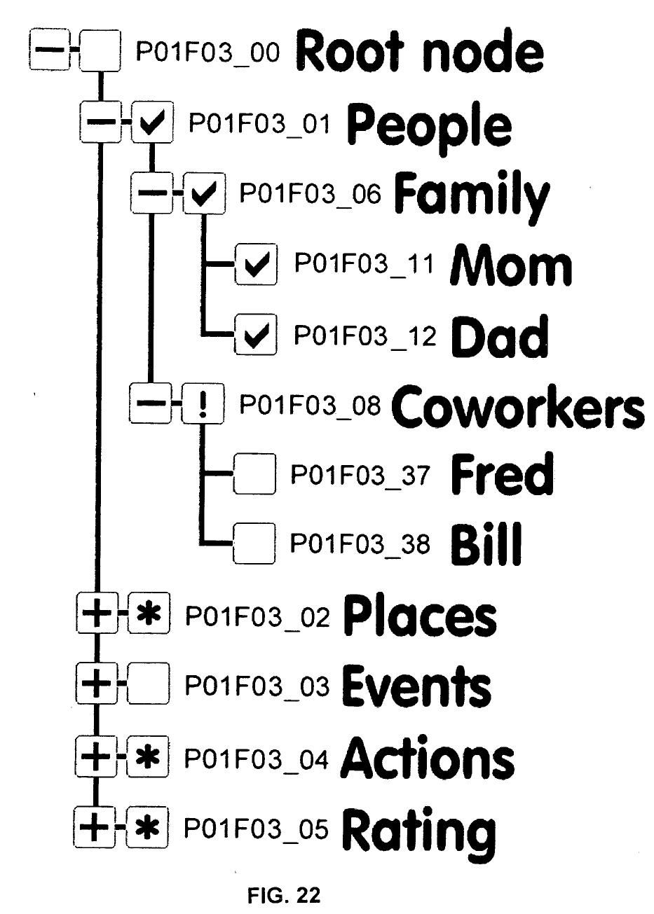

As shown in FIG. 22, the nodes “P01F03_11 Mom” and “P01F03_12 Dad” remain in the tree as current metadata and their sibling nodes seen in FIG. 21 (namely “P01F02_13 Me” and “P01F02_14 Jim”) have been hidden. The “P01F03_08 Coworkers” node is now expanded, revealing two more names, “P01F03_37 Fred” and “P01F03_38 Bill”.

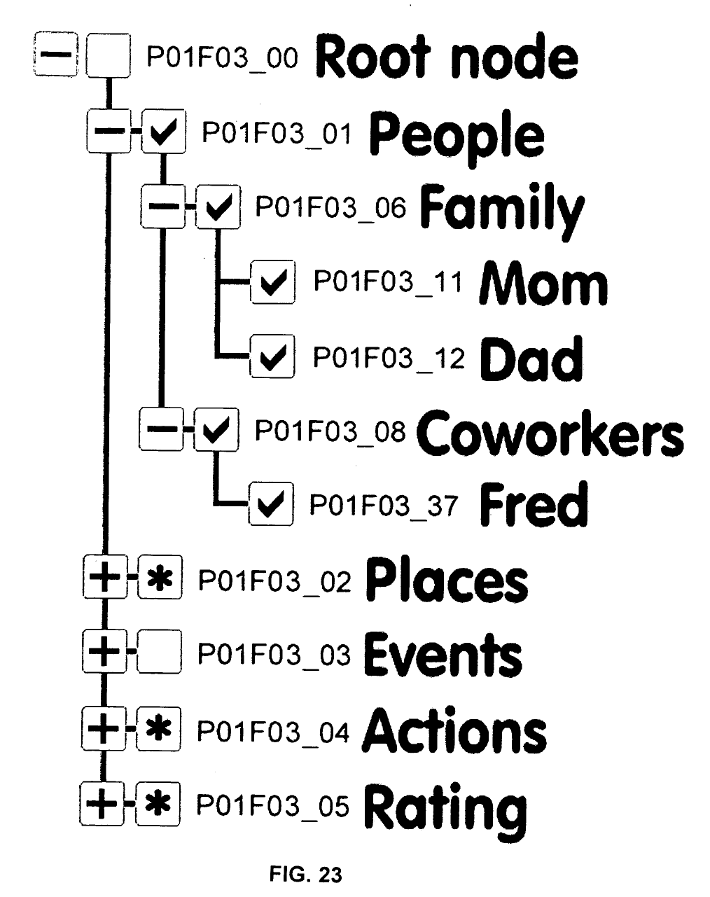

Clicking on “P01F03_37 Fred” without control will cause “P01F03_38 Bill” to disappear, the icon on “P01F03_37 Fred” to change. The resulting tree is shown in FIG. 23. Immediately following this, the “P01F03_02 Places” node at root level would automatically expand, since it's the next queued node.

In the case where previously embedded metadata exists in the file, a representative node will be shown in the tree, but it is passed over in the selection process unless explicitly configured while in “Tagset Mode” to be part of the progression and queued.

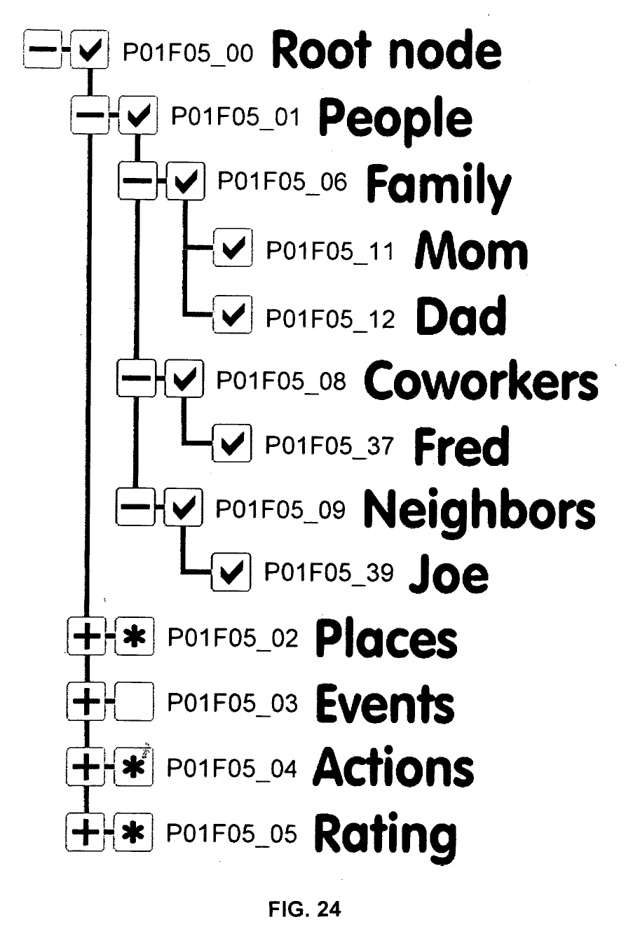

Thus if the photo used in the above example had originally included an embedded tag representing a Neighbor, “Joe”, the tree would appear as in FIG. 24. In spite of “P01F05_08 Coworkers” being the most recently activated node in the tree, and “P01F05_09 Neighbors” being immediately below, the next node will be the next * node (the next node previously designated for inclusion in the TAP), “P01F05_02 Places”.

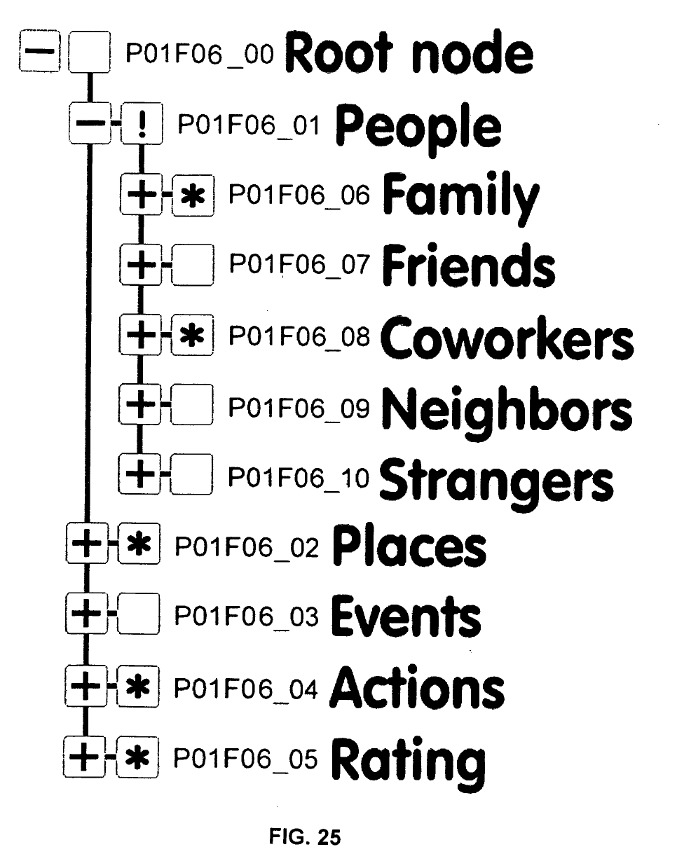

One intuitive way of indicating this is to start the TAP with the 4 top-level nodes indicated as if they had just been control clicked, and the initial expansion of the people node corresponds to the release of control. Then the process of finding the next node always consists of searching downwards within the tree, on the screen, from top to bottom, as the tree is displayed, and looking for the uppermost node having a ‘*’ it. See FIG. 25.

As the user presses a leaf node (a node lacking an “expand” box with a “+” indicator) or re-presses a non-leaf node to indicate that it is the last item in the chain to be embedded, the TAP chooses the next queued node in the tree to expand.

In the case of pressing a checked node, the result is always to remove the check but not change the activated node.

The process to find the next node to activate is as follows: Start with the node just pressed, then move up to the parent node and search for the next sibling node, with the additional requirement that the sibling node must be marked with a * icon. If one is found, use it. If not, continue up to the next ancestor.

It is a side-effect of the way trees are drawn that the lower-nested ‘*’ nodes will be visited before the higher nested (nodes at less depth relative to the root) ‘*’ nodes, with top level nodes only being visited once all the ‘*’ nodes in the previous top level node's descendants having been visited and operated on.

The above specification of finding the next node to activate is a generalization of the process used to get from “P01F05_39 Joe” to “P01F05_02 Places” in the original example.

Another action which is common in the use of a nested vocabulary is that the user may see a word that needs to be added to the keyword tree because it is not (yet) present under the appropriate parent node. When a node is ‘activated’ according to the “TAP mode”, any keystrokes typed by the user are interpreted to be keystrokes defining a new name under the activated node. When the user has finished typing, he can terminate the process with a click operation, pressing the “Enter” key, or other keystroke or mouse-initiated navigation.

In some cases, the user may type a name that is already in the keyword tree but not currently being shown in the tree (the node was not explicitly chosen to be included in the tagset). In this case, after a few characters have been typed, and those characters match the first few characters of an existing keyword, the existing keyword can be offered to the user, in a method similar to automatic word completion utilities on text editors.

Nodes added can be created in place, by inserting a new node and having the text of the node label being actively edited in place, or by popping up a prompt with a text entry field, then adding the new node to the tree, under the activated node, in the proper location. Another option is that a dedicated screen area can exist where nodes being formed by typing are displayed, and then transferred to the proper place when the user completes the process by Iciking elsewhere, pressing ‘enter’ or using tab or arrow keys to move the focus point.

In order to facilitate the addition of new nodes to the tree, during TAP mode, it is necessary to render them in the tree even though they would otherwise not be shown, by virtue of them being recently created, where the duration is until the next redraw of the tree due to the display of a new activated node. Newly created nodes added to the tree do not start out with checkbox (“this tag is assigned to the current file”) or asterisk (*, meaning “this tag will be visited in TAP”) icons. Nor are they “activated” (their parent was and remains the activated node.) The nodes are not hidden either: they remain visible until their parent is collapsed, so the user has a chance to either enter more nodes under the same activated node, or to control click nodes to apply both the newly created node and some nodes already present and displayed in the tree.

Specific keys that don't create characters used in keywords can be used to specify actions following completion of text entry for a single tag.

For example, the “Enter” key can be used to complete a tag, leaving the newly created tag's parent tag as the active tag, such that additional new tags (additional siblings to the tag just created) could be created by typing and pressing “Enter” for each new tag required.

The “Escape” key can be used to abandon tag creation once typing has begun.

The “Tab” key, pressed while the use is inputting a new tag node, can be used to perform multiple tasks in sequence, automatically, such as 1) complete the keyword, then 2) mark the keyword for assignment to the file, and 3) make the newly created tag the active tag, where any typing would make a child tag within that newly created tag.

There are some additional features that can be applied to a tree showing metadata, that come into play when the image is accessed for a second time, after tags have already been applied.

One option is to display the existing metadata in the tree as well as the nodes available for use in the TAP. The extra nodes are shown with an icon indicating they are in fact already in the metadata, but (in the case where they happen to have descendant nodes) they will not actually be visited as expandable nodes in the TAP. A checkbox-style indication associated with each tree node is sufficient to display this “already embedded” information, when in TAP mode, in conjunction with the ! and * nodes to indicate the active node and the nodes queued for becoming activated.

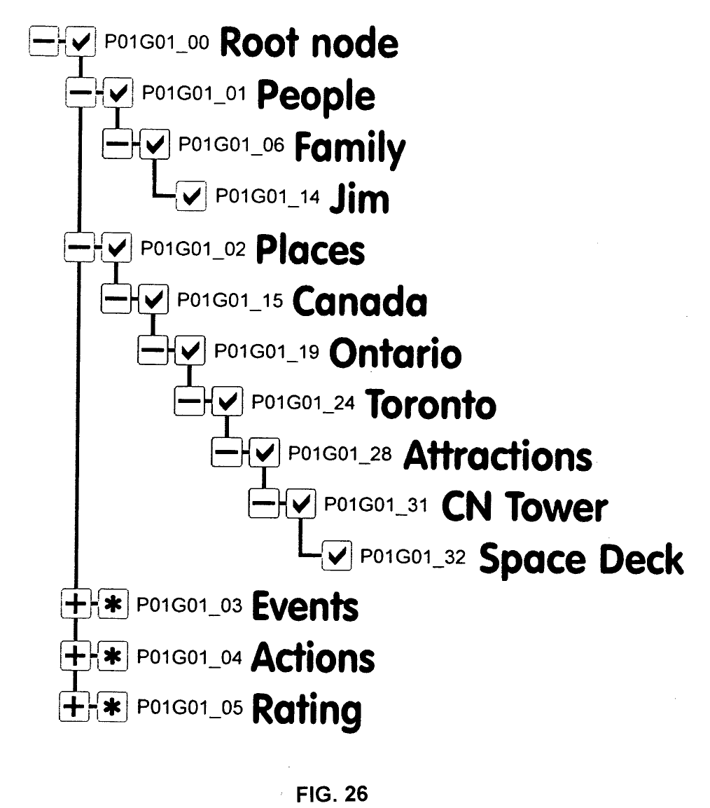

Paths of checked-off parent nodes that represent embedded metadata can remain expanded above the current node, so that it is possible by looking in the tree to see what metadata is already present in the file, without having to navigate (see FIG. 26). These will scroll out of view as the tree control is scrolled.

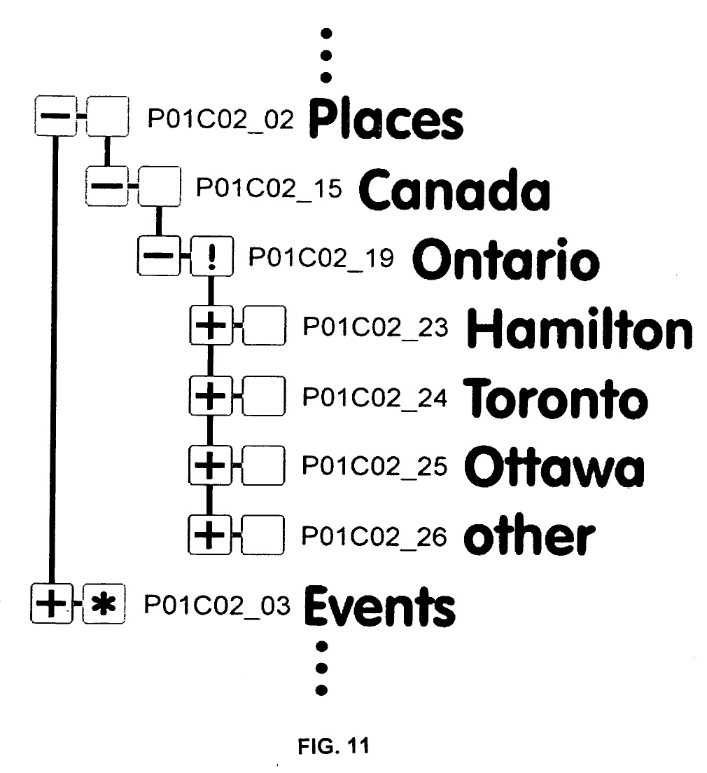

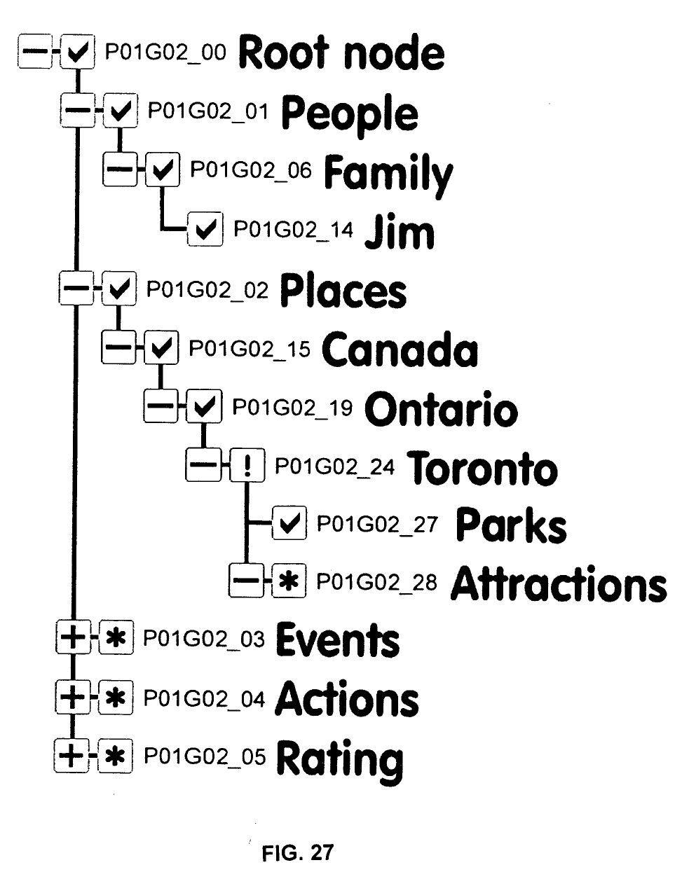

This is the default display method. The tree still has small + and − signs beside nodes, able to allow the user to expand and collapse these other nodes. The icons on the current active path in the process can be distinguished so that it is apparent what the current node is and what the result of clicking it will be. For instance, one may consider the process from the point represented in FIG. 11, and assume that the user clicks the “P01C02_24 Toronto” node, and only the child “P01C03_28 Attractions” node is has been designated in the tagset for inclusion in the TAP. Now referring to FIG. 27, when the Toronto node is expanded, in addition to the “P01G02_28 Attractions” node, the pre-existing embedded “P01G02_27 Parks” node is shown under “P01G02_24 Toronto”. The “P01G02_27 Parks” node has a checked checkbox, indicating that it was already embedded in the file, and the “P01G02_28 Attractions” node has a star indicating it is next in line to be visited.

The “P01G02_24 Toronto” node, being an ancestor of “P01G02_27 Parks” was incidentally also embedded in the file, but it's inclusion in the tagset and its' participation in the TAP dominates the ‘previously embedded’ flag, so rather than having a checkbox, it has the “!” icon, indicating it is the active node in the TAP.

When there is only one descendant node in the TagSet, it is logical that it could be automatically expanded, so the user need not click the only node available, “P01G02_28 Attractions”, before moving on in the TAP, but that method is only optimal when the user is confident that it will not be necessary to add nodes immediately under “P01G02_24 Toronto” (because automatically activating the “P01G02_28 Attractions” node would have the secondary effect of making “P01G02_28 Attractions” the focus of keystrokes.) Such advancing directly into descendant nodes is henceforth referred to as “bypassing nodes”. This is an optional setting for each node in a tagset, that allows for deeply-nested descendant nodes to “bypass” the ancestor to further compact the tree for the TAP, without reducing the granularity of the embedded metadata, specifically where the user is confident that it will be unnecessary to add many additional tags to the bypassed nodes during the TAP. The “bypass” function will be described elsewhere. In this example, we will assume “bypass” is not employed, so the user is presented with both the “P01G02_27 Parks” node, and the “P01G02_28 Attractions” node.

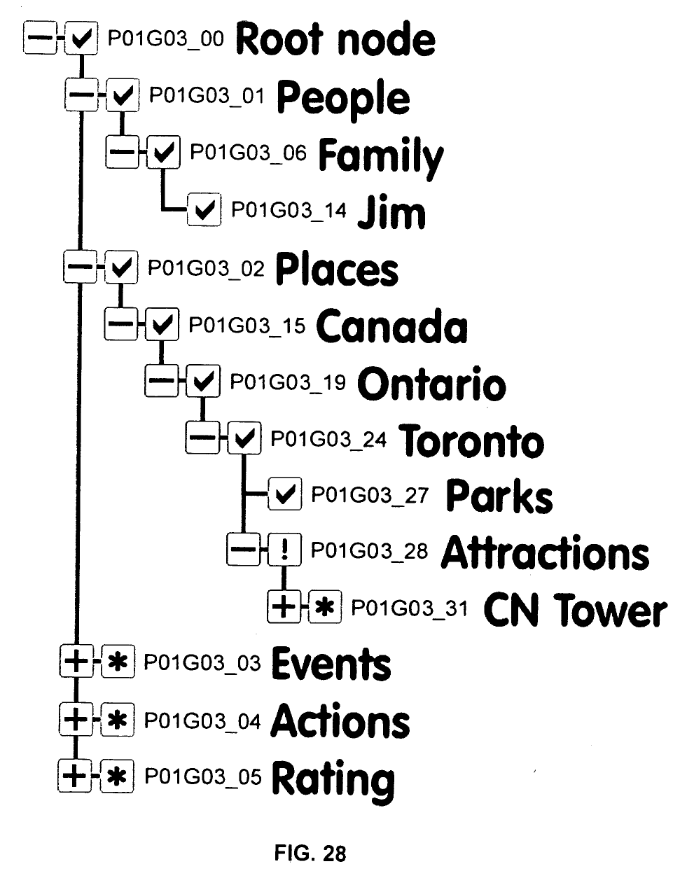

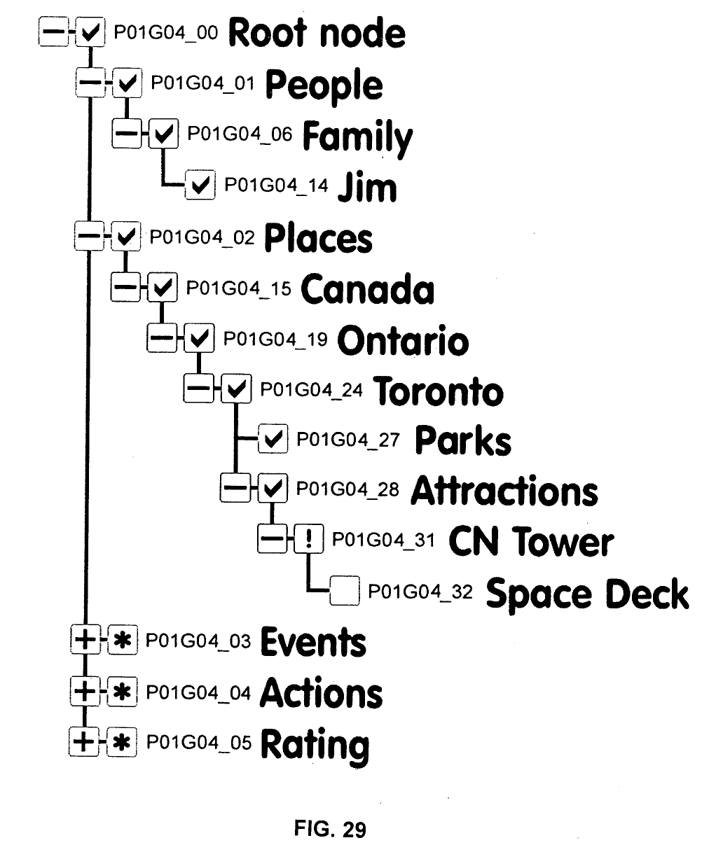

Thus, the user would click the “P01G02_28 Attractions” node, and the tree would appear as it does in FIG. 28. FIG. 29 shows the aftermath of clicking both the “P01G03_31 CN Tower” node, expanding the “P01G03_31 CN Tower” branch and showing it's only available child node, “P01G04_32 Space Deck”.

The foregoing descriptions showed how the “TAP mode” interface can be applied to a tree, taking into account the innovations that increase the efficiency of user interaction with the tree. The TAP can also be applied to a tabular chart form of selection.

First, a description of the current state of a column based user interface will be described. An example of this form of selection is in the keyword catalog pane of the commercially available “Image Info Toolkit” (IIT) program. In this mode, the columns contain the top level nodes, and then each column to the right can contain the list of child nodes of the selected node in the column before it. Additional information related to synonyms is supplied in the user interface under the columns, and can be used to clarify the selected item's meaning.

Currently the IIT user interface clears the columns to the right of the column containing the clicked item, when the item is first clicked. Double clicking the item will cause the next column to be populated with the nested child items of the double clicked item.

The IIT interface can be configured to show a limited number of columns, so that the top level root node may no longer be in view. This can allow some of the context to be temporarily not on display to the user, but it's probably not a problem in practice.

When the double click is performed in the right-most displayed column, if the clicked item has sub-items, the contents of all the displayed columns are shifted left and the top level (left most) nodes are no longer shown. This is similar to scrolling a narrow window containing a tree control, so that leaf nodes of a tree can be seen. It's possible to obscure the display of the parent nodes in this case. The missing information is likely still fresh in the mind of the user and therefore of little importance to remain visible. In any case the “Image Info Toolkit” program offers the ability to increase the number of displayed columns if desired by the user.

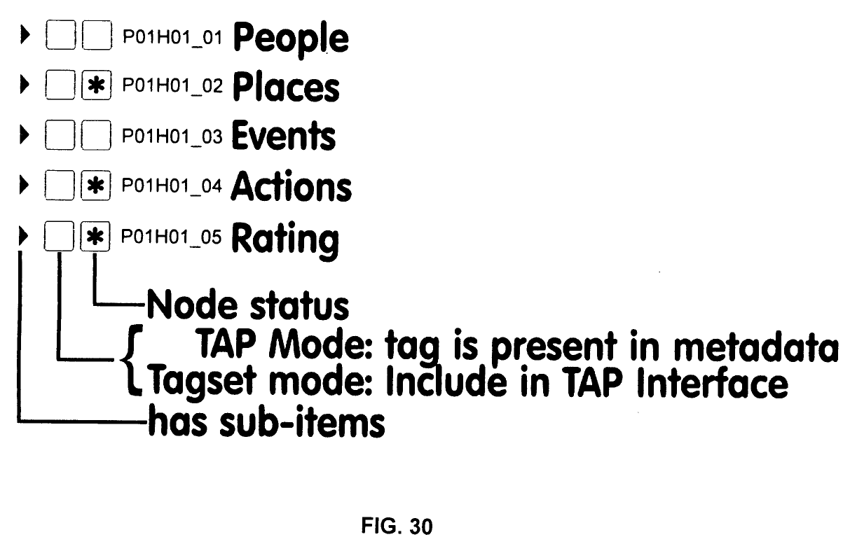

To modify such a system to support an analog of “Tap Mode”, there would have to be some minor changes in what is displayed and what happens when it is clicked. First, each item in the list, in addition to its > symbol indicating the presence of sub-items, needs to have a checkbox and an icon associated with its text label. When in “Tagset Mode”, the checkboxes will function similarly to those in the tree implementation: enabling the display of the corresponding node in “TAP Mode”. In “TAP mode”, the checkboxes in this interface can instead be used to represent information about existing or recently added metadata in the file(s) being operated on. See FIG. 30.

Due to the limitations of the multi-column format, effectively only one branch path of a tree can be properly populated at each level, with upper levels represented as stubs that include only the siblings of the deepest-level-node's parents. This is a valid rendering of a tree, but because of the single-expanded node per level nature of the table-based display, it is not possible in most cases to indicate all of the existing metadata, as was possible in the tree-based case described above.

Even without the ability to display the existing metadata in the same control, there's still ways to apply aspects of the TAP to improve the ease of use and efficiency of the multi-column display.

First, it is ensured that when an item is clicked, the next column of child items, if any exist, will be automatically shown in the column to the immediate right of the column containing the clicked node. This will save one click whenever the user wants to go deeper.

Second, treat a click on a node as a request to accept that piece of metadata into the file. Use the CTRL key to select multiple items in a given column, and upon release of the CTRL key, show the child items (if any) of the topmost node of those clicked, add the other clicked nodes to the process queue, and indicate their inclusion in the process queue with an icon on the node (by appropriate marking with a ‘*’ icon or equivalent). See Figure P01_node_icon_legend.

Because the multi-column display cannot show multiple branches of the tree, there's less need to suppress display of non-chosen parent items. However, if the number of parent items grows to the point where the window displaying the list will need to scroll, it's more advantageous to hide items not queued for activation.

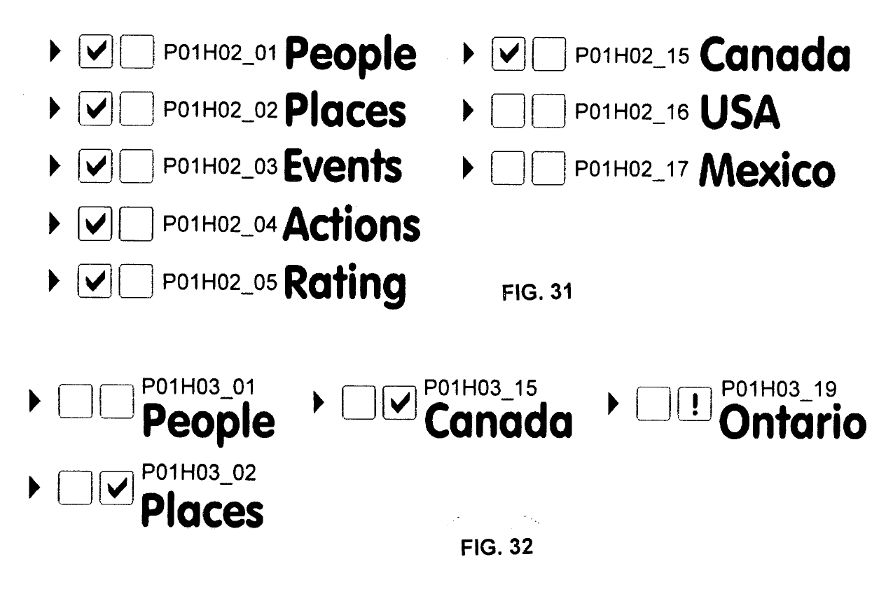

Referring to FIG. 30, clicking on a top level item, such as “P01H01_02 Places”, will show the contained items as shown in FIG. 31, such as “P01H02_15 Canada”, “P01H02_16 USA”, and “P01H02_17 Mexico”. After application of the “Tagset mode” configuration, the display can be placed into “TAP mode” and the following responses to clicking will be directly parallel to that of the TAP mode used for trees: clicking on the word “P01H02_15 Canada” would update the display and “P01H02_16 USA” and “P01H02_17 Mexico” would be hidden (see FIG. 32), a new column would appear to the right, with the child items of “P01H02_15 Canada” shown (namely the nodes included in the tagset from the list of nodes representing the 13 provinces/territories of Canada). In this example, shown in FIG. 32, only one node, “P01H03_19 Ontario” is included).

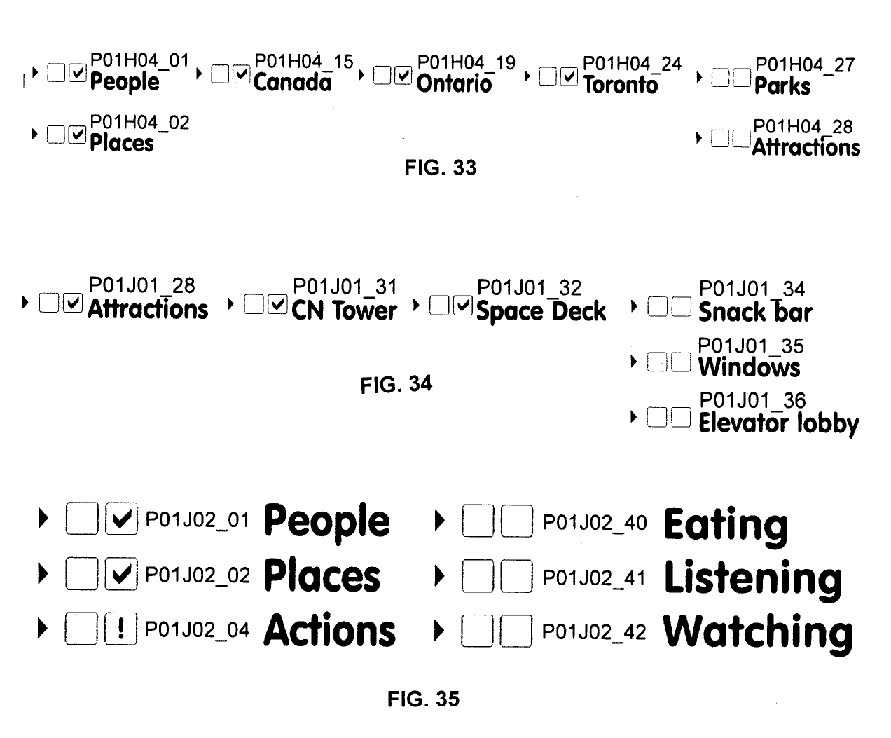

As an added optimization, in the case where only one item is in a given list (due to the fact that only one item at that level has been designated for inclusion in the tagset), it can be advantageous for the process to treat singleton items which have subitems as “clicked” automatically, progressing until more than one child node is available for the user to choose from. For example, see FIG. 33, which illustrates a tagset fragment that would be used for tagging a set of photo files depicting people in a specific place (such as the city of Toronto, Canada). Because of the settings in the Tagset applicable to this example, the other choices under ‘Places” and “Canada” and “Ontario” were not checked off, and therefore are not presented as choices.

The leftmost column shows both “P01H04_04 People” and “P01H04_02 Places”. For the purpose of this example, we will forego explanation of the process prior to the point where the “P01H04_02 Places” node is activated. Upon activation of the node “P01H04_02 Places”, the columns showing “P01H04_15 Canada”, “P01H04_19 Ontario”, and “P01H04_24 Toronto” would automatically appear in turn (but generally faster than the eye can perceive) with their single item checked as though clicked. As shown in FIG. 33, the node “P01H04_24 Toronto” has more than one descendant node included in the tagset, so the process is halted waiting for the user to choose one or more of the nodes in the column to the right of the column containing “P01H04_24 Toronto”.

The user can now click any of the activated parent nodes to terminate the “Places” branch at that node, or they can click or control click one or more of “P01H04_27 Parks” or “P01H04_28 Attractions”.

The user can indicate that they have tagged as far through a given branch as is required by clicking a second time on the checked node in the column to the left of the terminus. By clicking on the node “P01H04_24 Toronto” that would uncheck the node, effectively leaving “P01H04_19 Ontario” as the deepest-nested node that is checked.

In such a case, when the node is unclicked, and there being no other choices for the user in that column, the user interface would advance to the next node in the queue. So for instance, if no places metadata was to be indicated, the user would click on “P01H04_19 Ontario” to cause it to be unchecked, and the effect of the auto-checking and expansion would be undone.

With reference to FIG. 34, we will assume that the ancestors of the leftmost node shown, “P01J01_28 Attractions” would be in right-to-left order “Toronto”, “Ontario”, “Canada” and “Places. With the activated node being “P01J01_32 Space Deck”, showing its child nodes in the rightmost column, when the user clicks “P01J01_32 Space Deck” again, all but the two columns hosting the top two levels of nodes would be collapsed, and the next node in the queue would be activated, as shown in FIG. 35, assuming that the next top level node included in the tagset was “Actions”. The node “P01J02_04 Actions” is marked to indicate that it is the active node, and three child nodes that have been designated for inclusion in the tagset are shown in the second column.

The process for the computer to select the next queued node is not as intuitive as it is with a tree-based arrangement, because the several columns of the chart based control don't have an obvious top-to-bottom threading. In FIG. 35, only the * indicator on the node “P01J02_04 Actions” provides the user with feedback as to the parent node of the three items in the second column.

When a node is accepted, (clicking a leaf node or reclicking a non-leaf node), the process should proceed to the next node lower in that list which has a ‘*’. If no ‘*’ is found, then go to the next column to the left, start (possibly part way down the list) at the active node's parent, and search downwards for the next ‘*’ node.

In a manner similar to the use in the trees, the top-level nodes of the keyword vocabulary (in the left-most column overall) can be considered to all have * icons on them. (I.e., notionally control clicked each time a new item is presented for tagging).

As in the tree-based implementation, if the user types a new word, it can be considered to be a new child for the activated node. Also, as before, if the user starts typing an existing name not displayed because it was excluded from the tagset, then the word can be offered to the user in a manner consistent with auto completion features in other apps such as Microsoft Word.

Regardless of the basic presentation of the TAP interface, when the last node of the last branch has been clicked or dismissed, it's time to finish the metadata application process and move on to the next file.

Depending on the complexity of the metadata embedding process, this can take a significant fraction of a second to accomplish. A pipelined program flow can use multi threaded techniques to pre-load the next file, so it's ready to tag as soon as the previous image is dispatched. Higher priority can be given to the software that displays and prepares the interface for tagging the next file. Then, using the spare time while the user is choosing the next tags to apply, the updates to the metadata on the previous file or batch of files can be completed.

It may also be advantageous to suppress display of the checkboxes that are used in “Tagset Mode” to indicate whether or not a given node is to be included in the tagset and therefore shown in the TAP. In that case, referring to FIG. 30, the left column of icons (indicating whether a node has children in the tagset) would remain, and the second column would be removed, and the third column (labeled “Node Status”) would also serve to indicate whether the tag is present in the metadata, possibly employing different symbols or colours to indicate more than one characteristic (for example that the node was previously embedded in the file, but the node is in the process queue.) In one embodiment of the invention, this may be accomplished with different icons and different colour indicators.

The preceding embodiments of the invention have disclosed methods for guiding the user through the a process of associating metadata tags with a file, in which tag node subsets are sequentially presented to the user for tag node selection. In an additional preferred embodiment of the invention, all primary and intermediate tag nodes within the hierarchal structure of the set of tabs are presented to the user, and the user is guided through a process in which the leaf nodes belonging to the primary and intermediate tag nodes are presented.

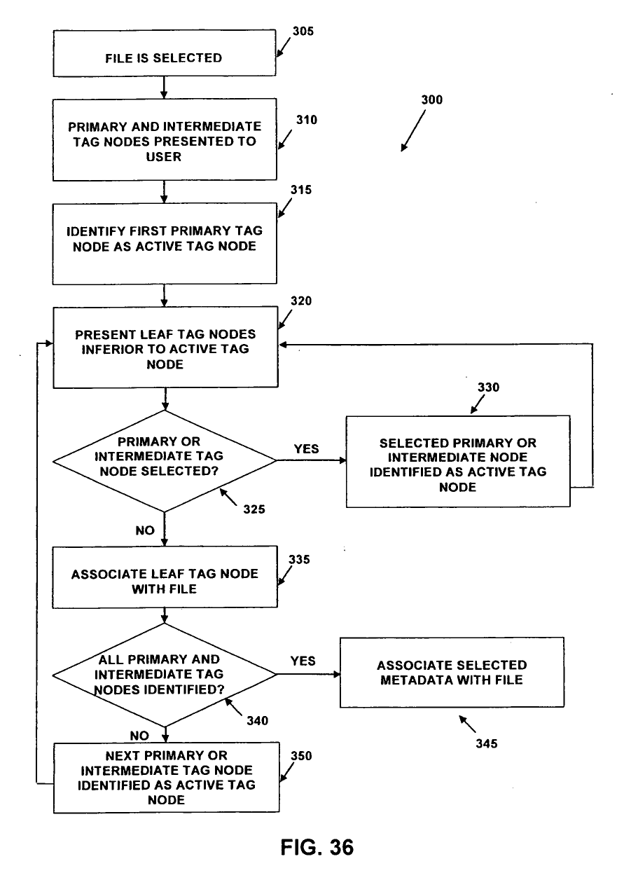

The method is shown in FIG. 36 at 300 as a flow chart as in FIGS. 1 and 2. In a first step 305 of the illustrated method, a file is selected to be associated with one or more metadata tags. Unlike previous embodiments, the method presents a list of all primary and intermediate tag nodes to the user in step 310. A first primary tag node is subsequently identified as an active tag node in step 315. The user is then presented with the leaf tag nodes belonging to the active tag node in step 320, if any exist. In step 325, the user may then select a leaf tag node to associate with the file in step 330, or may select another primary or intermediate tag node. If a leaf tag node is selected, and if there are primary and/or intermediate tag nodes that have not yet been identified (see step 340), then the active tag node is modified to become the next tag node in the list of primary and intermediate tag nodes in step 350, and the process is repeated starting with step 320.

If, on the other hand, the user selects another tag node from the list of primary and intermediate tag nodes in step 325, then the active tag node is modified to become the selected tag node, and the process is repeated starting with step 320.

The above process continues until it is determined in step 340 that all primary and intermediate tag nodes have been identified, i.e. the user has had the opportunity to tag the file with tag nodes descendant to all primary and intermediate tag nodes. The collection of tag nodes associated by the user by the selection of leaf tag nodes (if any) is subsequently stored in association with the selected file in step 345.

As in the preceding embodiments, the user may terminate the tag selection process at any time during the aforementioned steps, for example, by the selection or actuation of a user interface button or context menu item.

This preferred embodiment is henceforth described in a specific but non-limiting example in which various enhancements are disclosed to increase efficiency and overcome various shortcomings inherent in prior art methods.

These embodiments address shortcomings with tree-based metadata management schemes. A tree structure has very small controls for expansion and collapse of branches, compared to the size of the text labels on the nodes. Thus it puts additional requirement so on mouse-pointing skill, making it more difficult for a child or handicapped person to access without need for correction of mis-clicks.

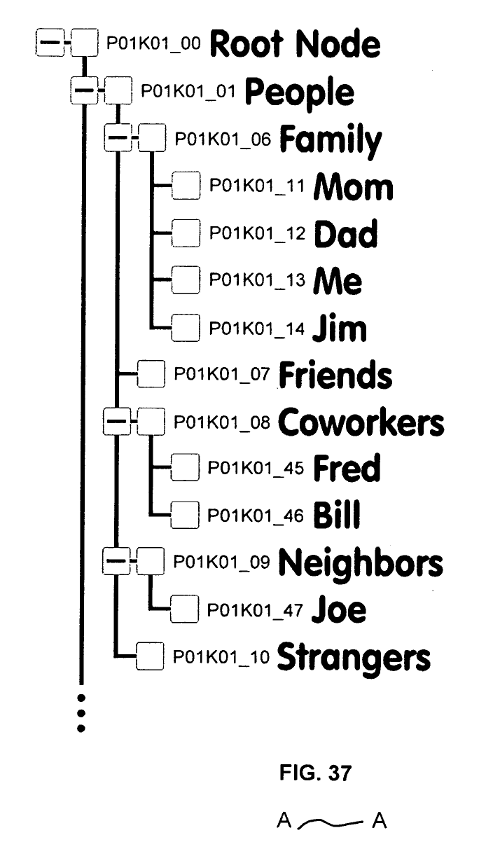

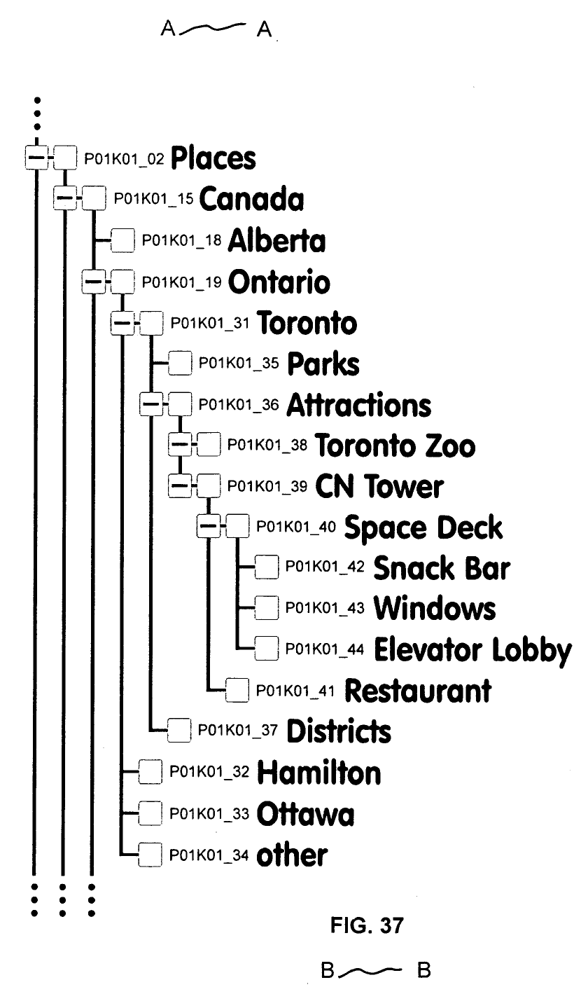

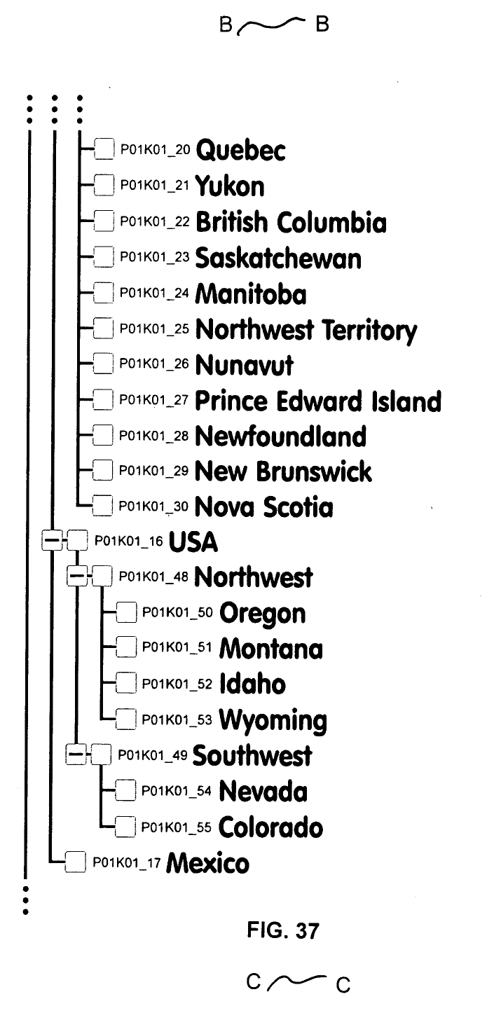

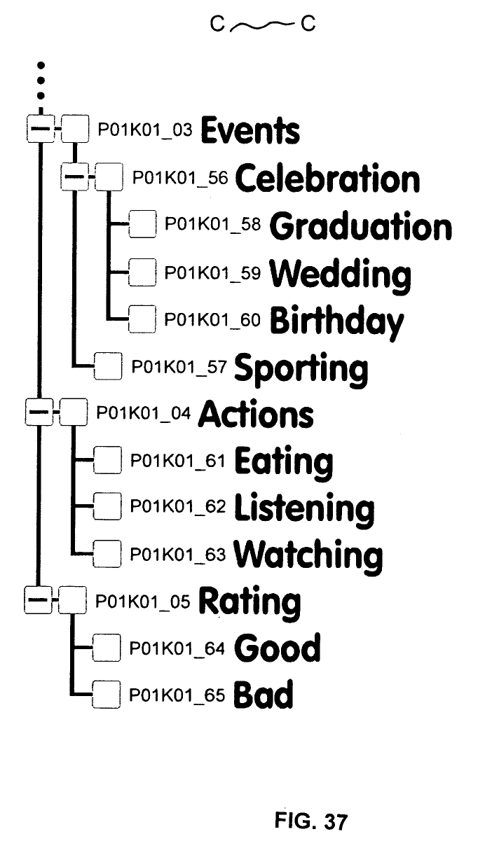

All the following examples and diagrams relate to a hierarchical tag vocabulary as shown in FIG. 37. In the following progression, the TAP interface will be described step-wise, and built up, so that it will be clear as each additional feature is added, how it applies to the edifice already described. To this end, the earlier descriptions do not so much describe the invention as they do describe the process that a programmer would imagine creating the invention. By the end of the description, all the aspects have been described, and the resulting figures describe the completed invention.

A direct translation of the hierarchical tag vocabulary tree to a tab control is a one to one relationship to tags having descendant nodes becoming tabs, and tags that do not have descendant nodes becoming buttons on tabs.

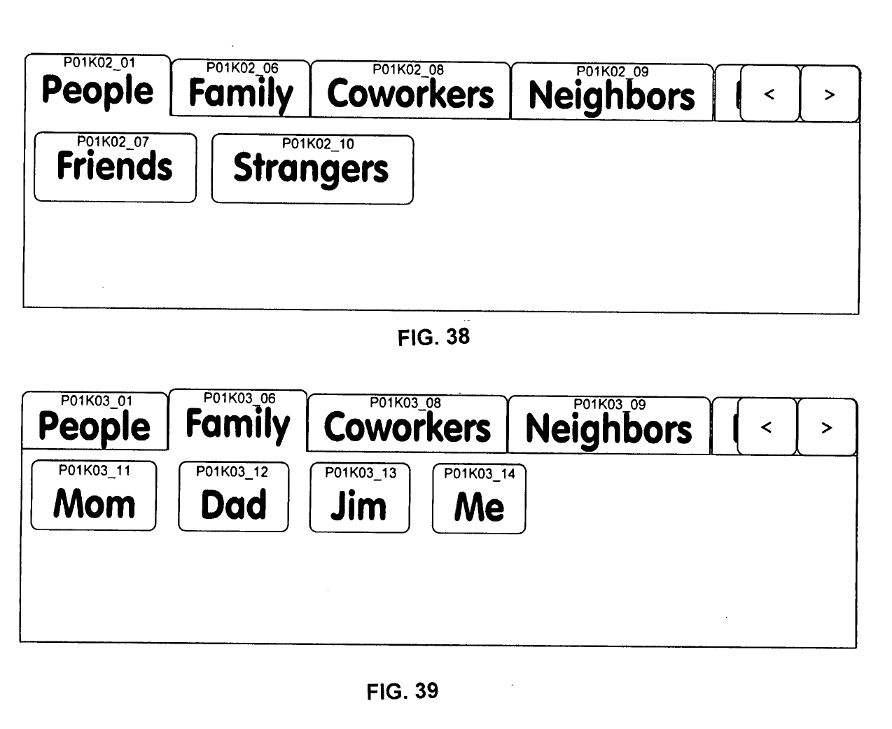

Referring to FIG. 37, tags having a “minus” icon adjacent to them are those that have descendants. In FIG. 38, a tab control rendering is made, where each tag having descendants is represented only as a tab, and those not having descendants are rendered only as button controls on the tab that represents their parent node.

The order in which the tabs are rendered in the tab control follows a linear path down to the deepest node that has descendants, then going up to the next node having descendants. (Depth first). Tab nodes are nodes which have child nodes, and therefore, the child elements can be rendered as buttons on the tab. Table 1 below provides a list of the tabs in order based on the nodes in FIG. 37.

TABLE 1
Ordered list of tabs shown in FIG. 37.

P01K01_01 People
P01K01_06 Family
P01K01_08 Coworkers
P01K01_09 Neighbors
P01K01_02 Places
P01K01_15 Canada
P01K01_19 Ontario
P01K01_31 Toronto
P01K01_36 Attractions
P01K01_39 CN Tower
P01K01_40 Space Deck
P01K01_16 USA
P01K01_48 Northwest
P01K01_49 Southwest
P01K01_03 Events
P01K01_56 Celebration
P01K01_04 Actions
P01K01_05 Rating

Note that the tab control automatically renders navigation buttons (the two arrow buttons at the top right of the figure) when there are more tabs than can be rendered in the space provided. This provides the means for the user to navigate to other tabs.

In the tag vocabulary hierarchy (FIG. 37), the only descendant nodes of the first node “P01K01_01 People” that do not have descendants of their own are “P01K01_07 Friends” and “P01K01_10 Strangers”, and are rendered as in FIG. 38 as the only buttons on the tab “P01K02_01 People”. Another example is shown in FIG. 39, rendering the node “P01K01_06 Family” as a tab. The nodes that will be rendered as buttons, and the tab that represents their parent node are listed in Table 2 below:

TABLE 2
Listing of tabs and buttons in the examples shown in the Figures.

| TABS | BUTTONS |
|---|---|
| P01K01_01 People | P01K01_07 Friends |
| | P01K01_10 Strangers |
| P01K01_06 Family | P01K01_11 Mom |
| | P01K01_12 Dad |
| | P01K01_13 Me |
| | P01K01_14 Jim |
| P01K01_08 Coworkers | P01K01_45 Fred |
| | P01K01_46 Bill |
| P01K01_09 Neighbors | P01K01_47 Joe |
| P01K01_02 Places | P01K01_17 Mexico |
| P01K01_15 Canada | P01K01_18 Alberta |
| | P01K01_20 Quebec |
| | P01K01_21 Yukon |
| | P01K01_22 British Columbia |
| | P01K01_23 Saskatchewan |
| | P01K01_24 Manitoba |
| | P01K01_21 Northwest Territory |
| | P01K01_26 Nunavut |
| | P01K01_27 Prince Edward Island |
| | P01K01_28 Newfoundland |
| | P01K01_29 New Brunswick |
| | P01K01_30 Nova Scotia |
| P01K01_19 Ontario | P01K01_32 Hamilton |
| | P01K01_33 Ottawa |
| | P01K01_34 other |
| P01K01_31 Toronto | P01K01_35 Parks |
| | P01K01_37 Districts |
| P01K01_36 Attractions | P01K01_38 Toronto Zoo |
| P01K01_39 CN Tower | P01K01_32 Restaurant |
| P01K01_40 Space Deck | P01K01_42 Snack Bar |
| | P01K01_43 Windows |
| | P01K01_44 Elevator Lobby |
| P01K01_16 USA | {no buttons rendered as there are no |
| | child nodes having descendants} |
| P01K01_48 Northwest | P01K01_50 Oregon |
| | P01K01_51 Montana |
| | P01K01_52 Idaho |
| | P01K01_53 Wyoming |
| P01K01_49 Southwest | P01K01_54 Nevada |
| | P01K01_55 Colorado |
| P01K01_03 Events | P01K01_57 Sporting |
| P01K01_56 Celebration | P01K01_58 Graduation |
| | P01K01_59 Wedding |
| | P01K01_60 Birthday |
| P01K01_04 Actions | P01K01_61 Eating |
| | P01K01_62 Listening |
| | P01K01_63 Watching |
| P01K01_05 Rating | P01K01_64 Good |
| | P01K01_65 Bad |

Using the rendering of the tree onto tabs and buttons as described so far, to tag files, the user would have a rendering of the file (be it a photo, music file, word processor document, etc.) then select tabs that represent categories of tags that pertain to the file, then click a button on the tab to apply that metadata to the file. When they are finished tagging, a click on a toolbar button labeled “Done” causes a write of the applicable metadata into the file, and the next file in the queue is automatically loaded.

The effort required to manually navigate between tabs can be daunting: the user has to manually click the tab label to foreground the tab, then click the button that pertains to the tab, then use the tab control navigation arrows to navigate to other pertinent tabs, repeating the process for all tabs.

A modification to the behaviour of the tab control will simplify this process. Starting with the left-most tab in the tab control tabs collection, the next tab will be foregrounded as soon as a button is pressed on a tab. (Note that in windows, it's the release of the mouse click that actually causes the button operation, but the press of the mouse click causes the button to be ‘pressed’ in appearance).

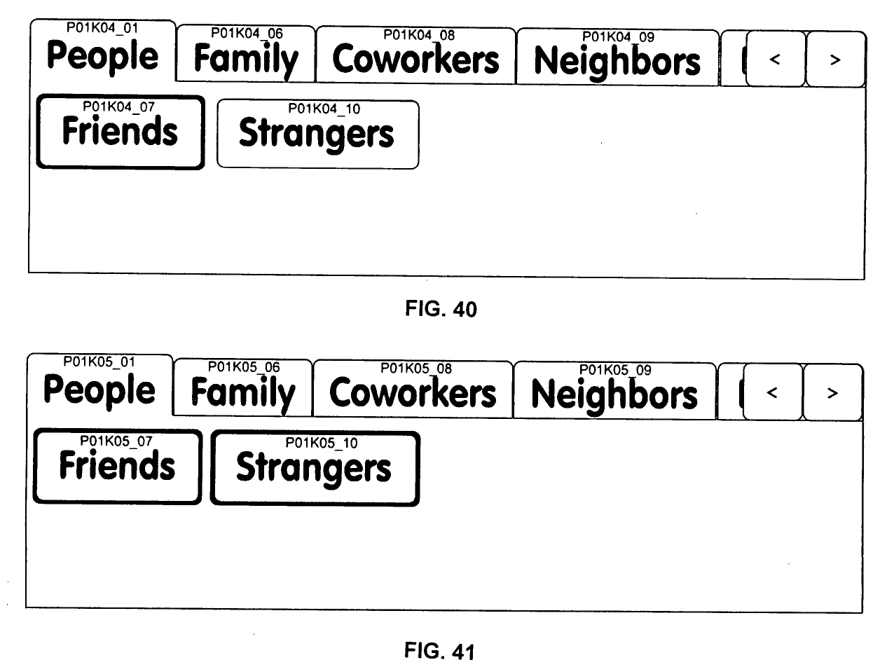

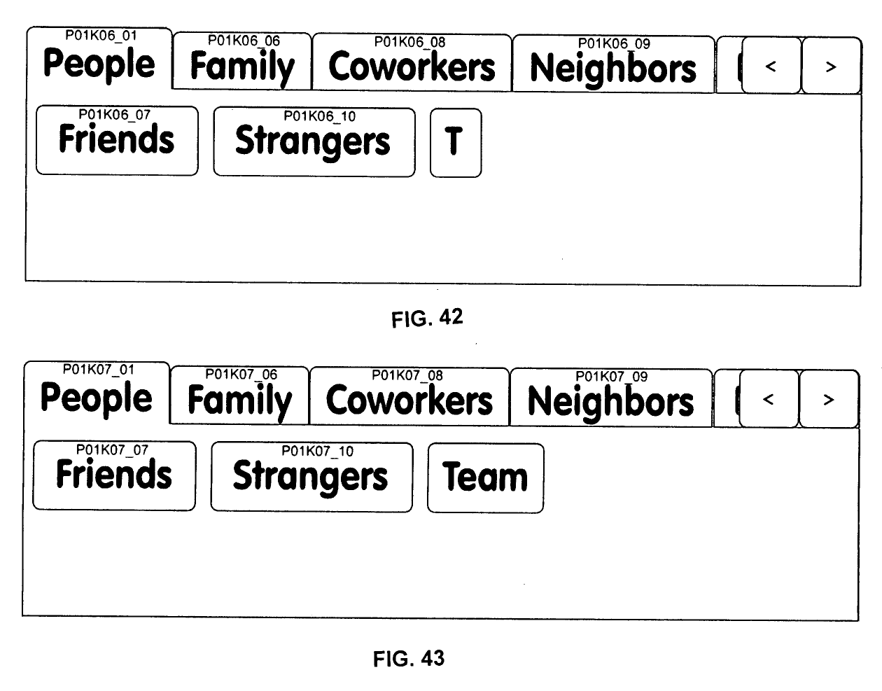

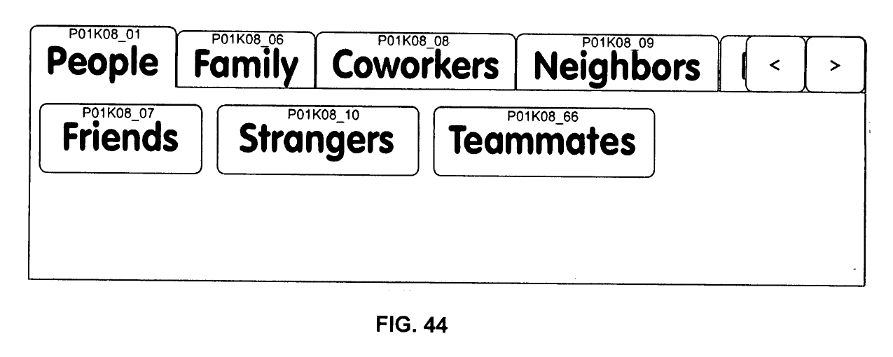

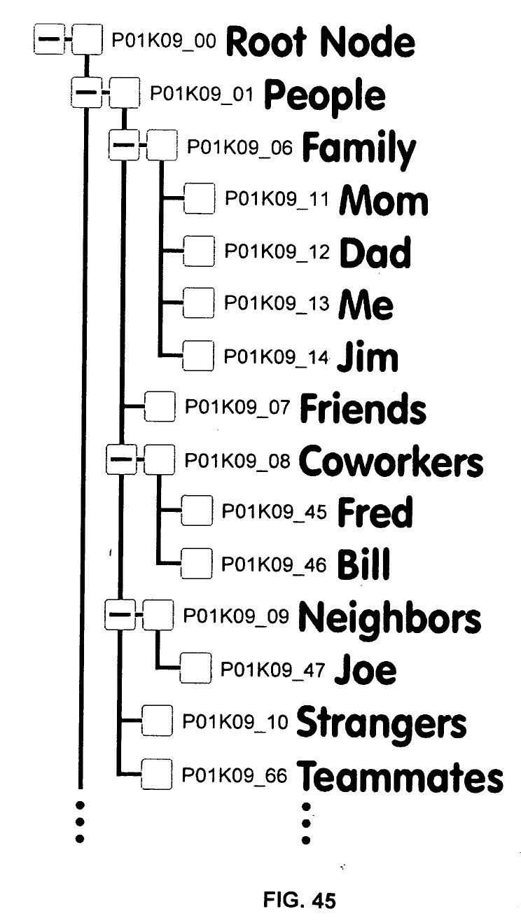

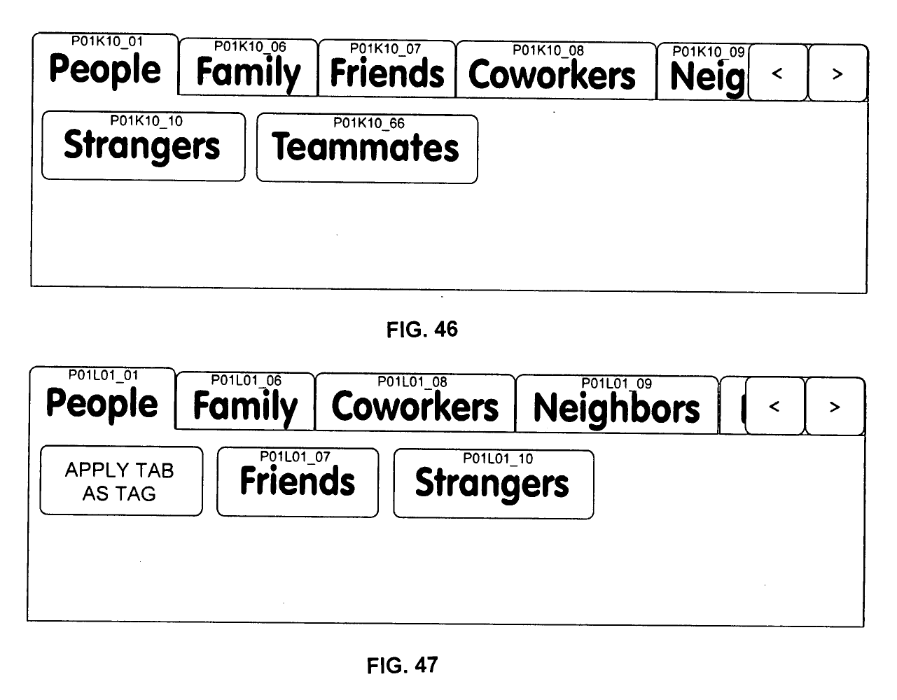

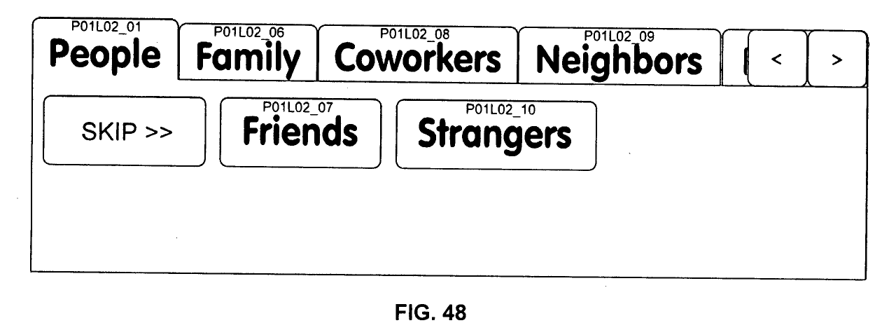

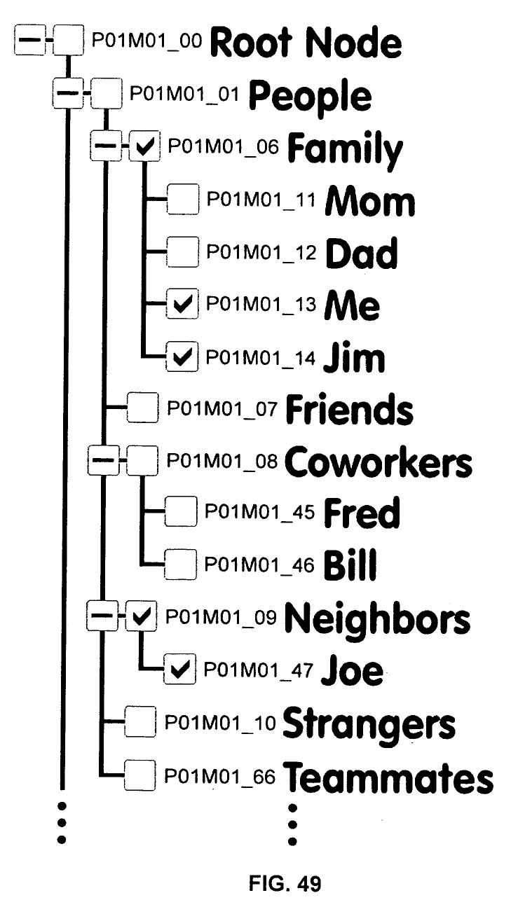

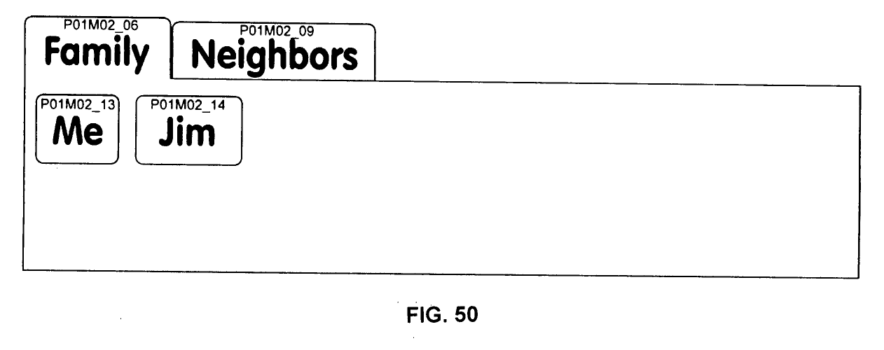

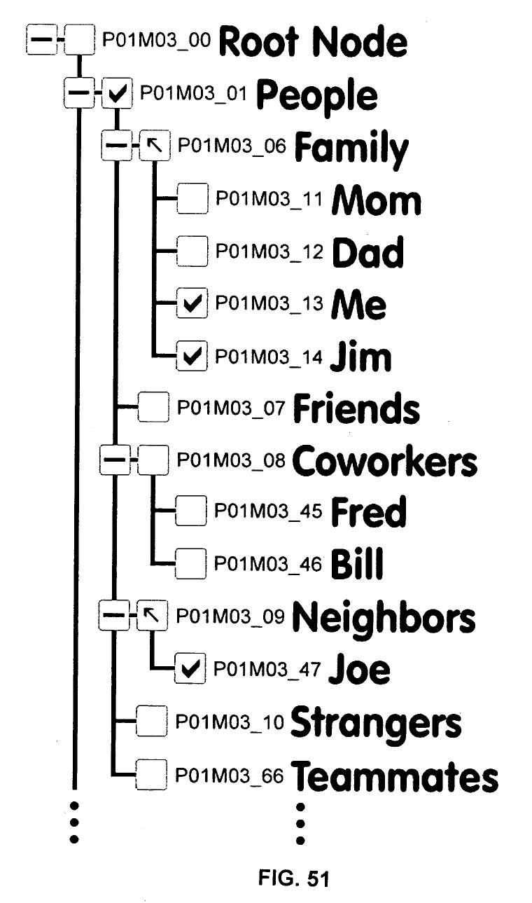

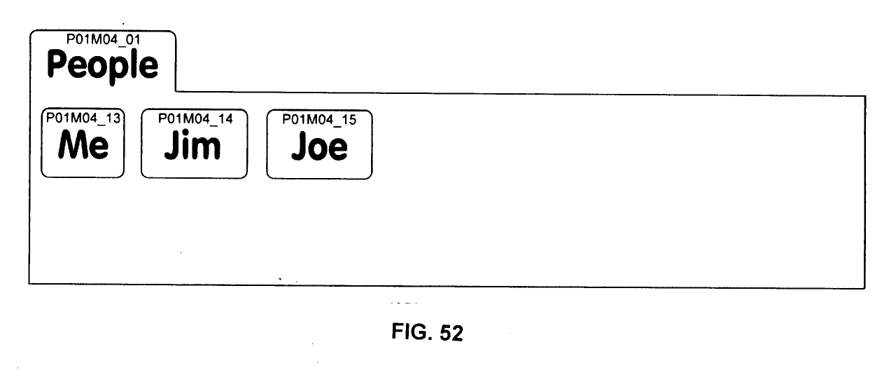

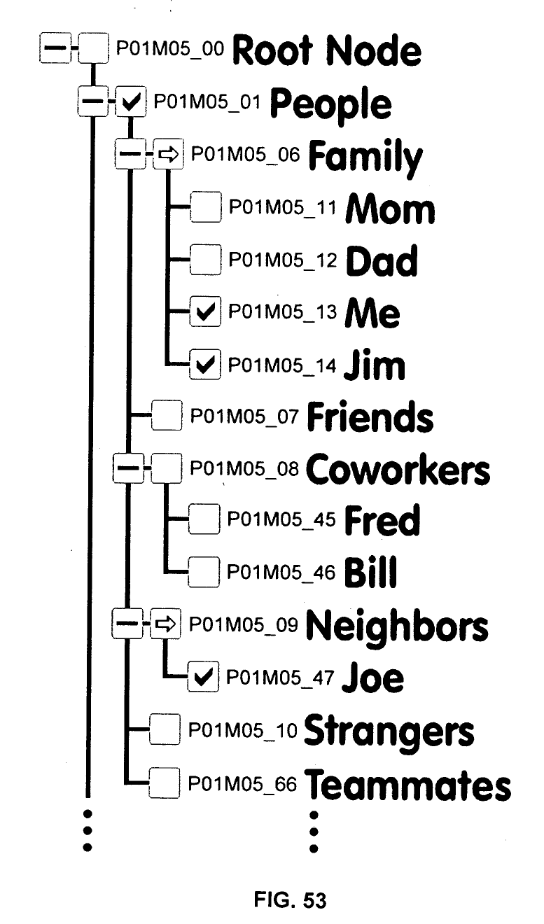

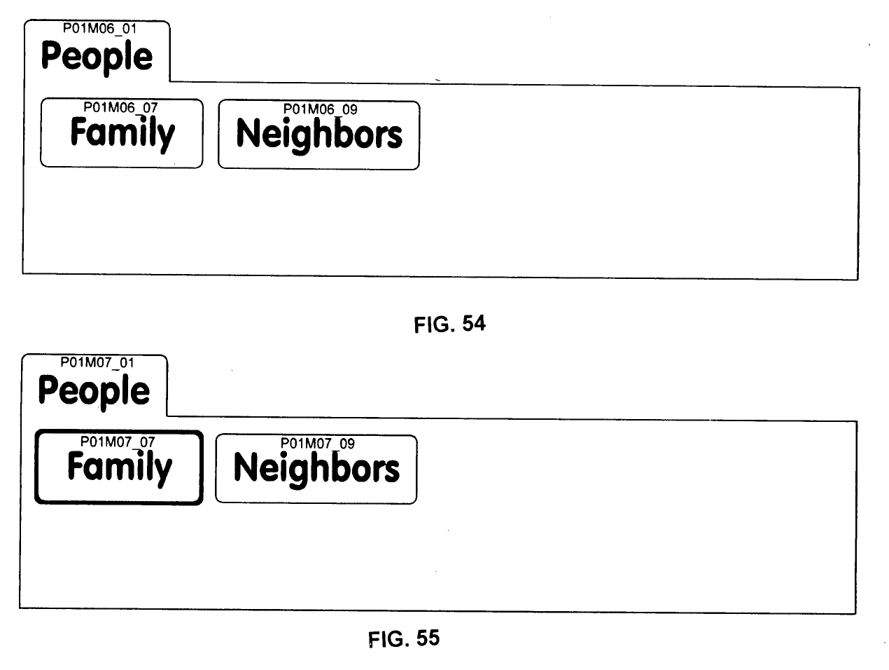

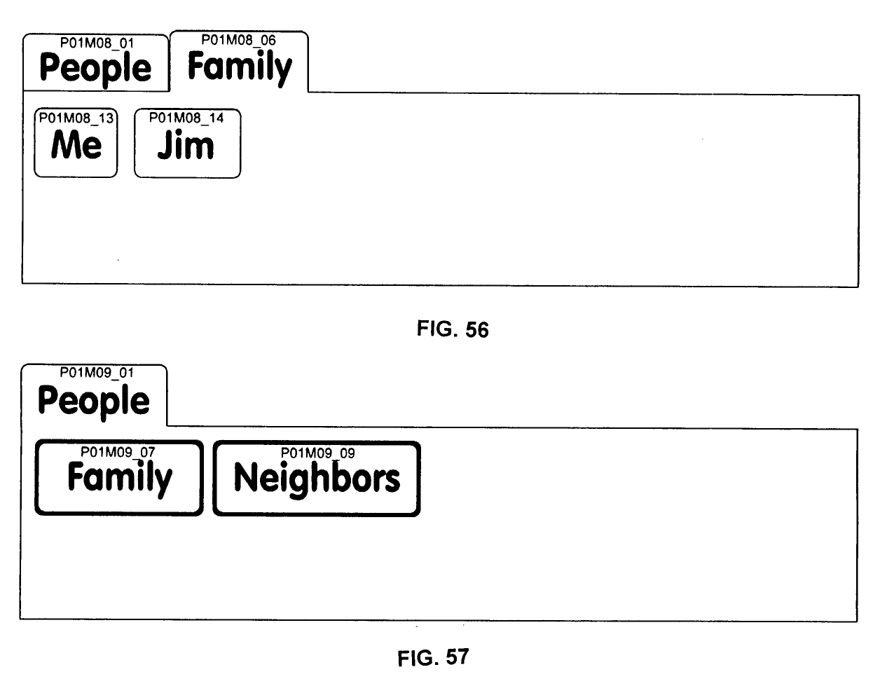

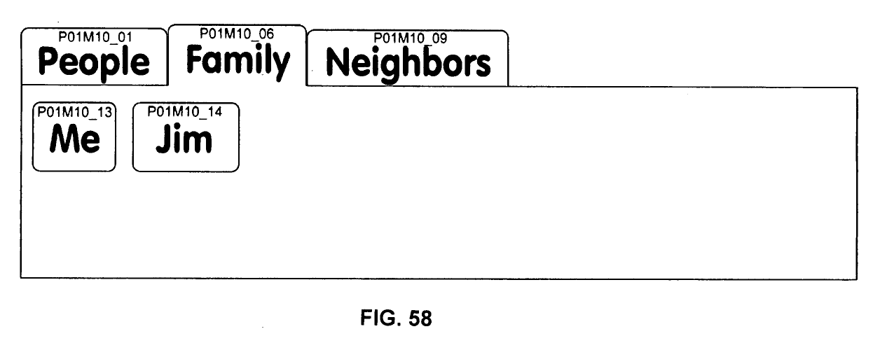

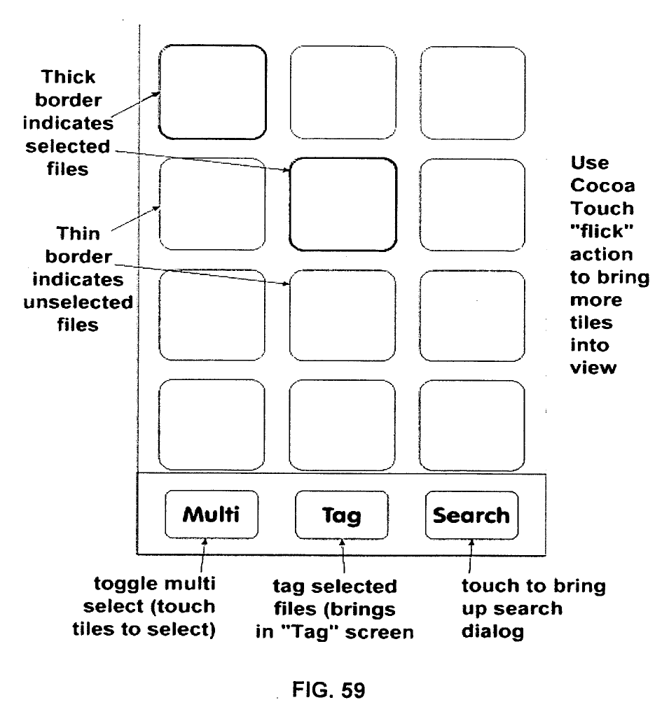

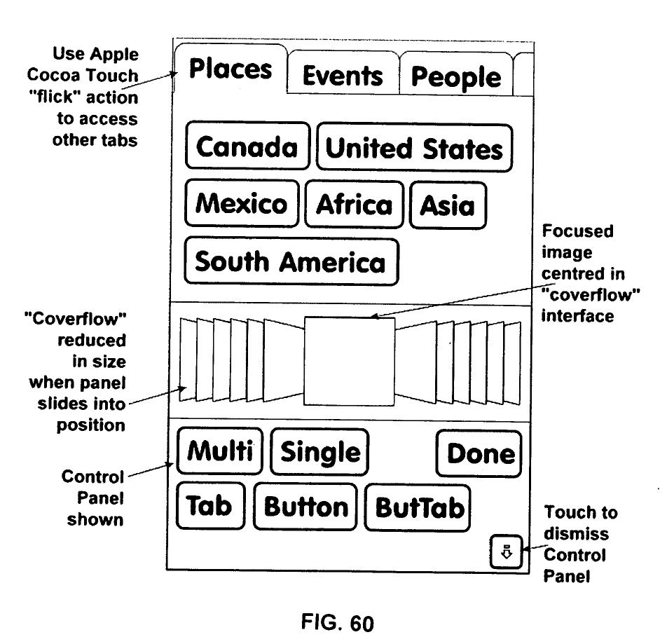

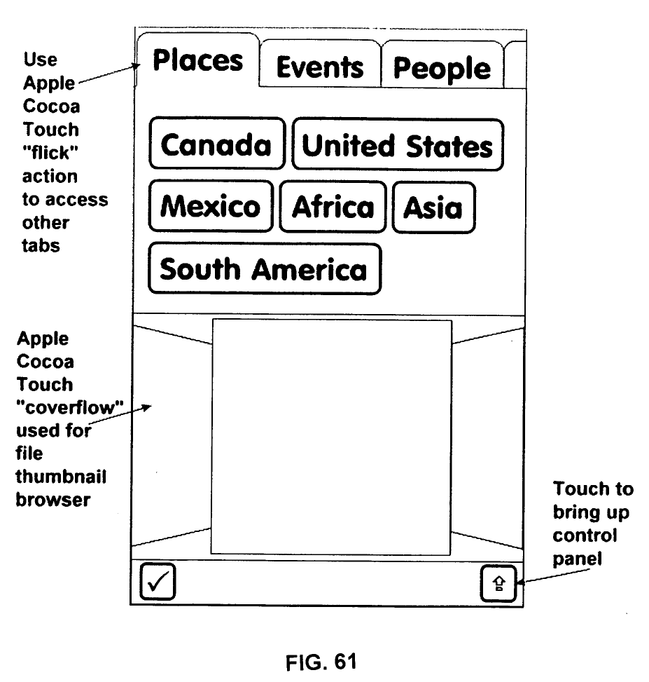

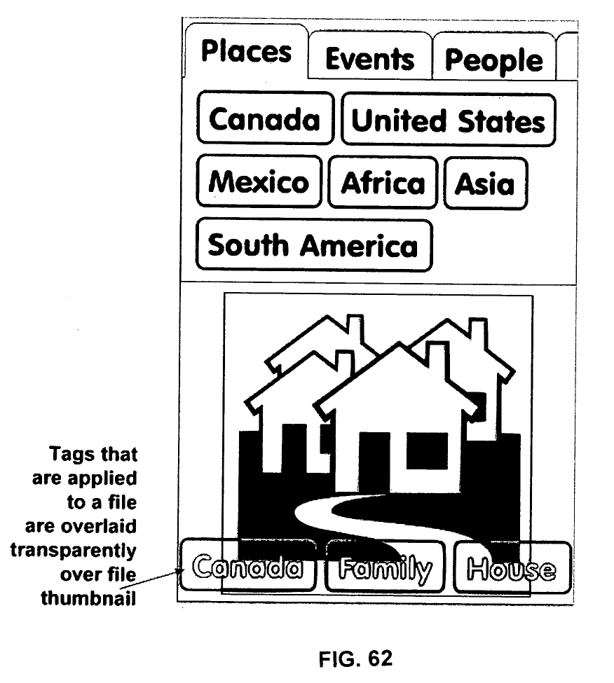

Referring now to FIG. 38, if the user clicks on the button labeled “P01K02_07 Friends”, while the mouse button is held down, the user interface would appear as it does in FIG. 40, with the button labeled “P01K02_07 Friends” appearing ‘pressed’, once the mouse button is released, then the next tab would be foregrounded, as shown in FIG. 39. Clicking any button on the tab labeled “P01K03_06 Family” would foreground the tab labeled “P01K03_08 Coworkers”, and so on.

When the user clicks a button on the last tab (the rightmost) the metadata is considered to be correct, and applied to the file (either embedded in the file itself, or as database entries, or a secondary file, etc.). The next file in the queue is loaded automatically, the first tab (leftmost tab) in the TAP order is given focus, and the process is repeated.

It is important for the user to know which tags have been applied to a file. Buttons will behave in a manner similar to formatting toolbar buttons common to word-processor software. See FIG. 40 for an example of how a button representing an applied tag would appear, with a thick border. Specifically, the button labeled “P01K04_07 Friends”. Optionally, the text label on the button could be bolded or the colour of the button changed.

A weakness in this process (as described thus far) is exposed when the user wants to apply more than one tag from a given tab. See FIG. 38. If a file being tagged is a photo, and that photo depicts people in the classes of both “friends” and “strangers”, the user would click one of the buttons on the tab labeled “P01K02_01 People”, then be automatically navigated to the next tab, “P01K02_06 Family”, then have to manually click the tab label “P01K02_01 People” to click the second button.

By using modifier keys, the behaviour of the mouse clicks can be changed for cases where multiple buttons are needed on a single tab. Using the standard operating system item selection modifier key, “CTRL”, the user can multi-select buttons in the following manner.

Referring now to FIG. 38, the user would press and hold the “CTRL” key, then click the button “P01K02_07 Friends”. The “P01K02_07 Friends” button would be shown as being depressed, as in FIG. 40, the button “P01K04_07 Friends”. While still holding the “CTRL” key, the user would then click the button labeled “P01K04_10 Strangers”. The user interface would change to appear as in FIG. 39, with both buttons on the tab “P01K05_01 People” showing as being depressed.

When the user is satisfied that all the buttons on a given tab that are to be applied have been clicked, the user will release the “CTRL” key, and the next tab would be foregrounded, and the user interface would appear as it does in FIG. 39.

The user needs a mechanism to add new tags to the user interface. This is accomplished by typing. When a tab is foregrounded, any text typed will be used to craft a button. Suppose the user wants to create a new tag on the tab “P01K02_01 People”, called “Teammates”. When the first keystroke is typed, a new button object appears on the foregrounded tab, with the single character displayed, as shown in FIG. 42, the button labeled ‘T’.

As they continue to type, the button is automatically resized such that it gets longer in the direction of the text flow (left to right in this example), such that once the text “Team” has been entered, the user interface will appear as it does in FIG. 43.

The user is able to use the “Backspace” key to edit the string in place, or press the “ESC” key to cancel creation of the new tag. When the user has entered the complete text for the tag, they can use the mouse button to click on the button to apply it immediately, or click a region of the screen outside the area of the button to indicate that typing of this tag is complete, and that any additional text entry will be interpreted as starting to create a new tag.

Creating the tag also adds a node to the hierarchical tag vocabulary in place as a child element of the node represented by the tab label. See FIG. 37. With the tag created as shown in FIG. 44, the node would be created in the tree as a child of the node “P01K01_01 People”. See FIG. 45 and note that a new node, “P01K09_66 Teammates” has been added as the last child of the node “P01K09_01 People”.

As the user progresses through the TAP, it is difficult for the user to remember all the details of the tags they have assigned: therefore, an additional tab is added to the end of the tab order with a label “Summary”, where all the leaf nodes tagged are presented as buttons. If the user sees any tags that on subsequent review they think are inapplicable, a single-click on the button on the Summary Tab will ‘unpress’ that button, and the tag will not be applied. Unlike other tabs, when a button is clicked on the Summary tab, the ‘next tab’ will not be foregrounded, as the Summary tab is the last in the tab order. A press of a “Done” button is required to commit the metadata for the file, load the next file to be tagged, and foreground the leftmost tab.

Some tags that are represented as buttons on tabs are themselves suited to having child tags themselves. Rather than access a distinct part of the user interface to create the child nodes, a context menu item (Right-mouse click menu) can be used to change a button to a tab, (which inserts the tab into the order to the right of the tab previously showing the button), and while said newly inserted tab is displayed, the previously described text entry method can be used to create tags.

Referring now to FIG. 44, the user can change the button labeled “P01K08_07 Friends” to a tab by right-clicking the button, and choosing “Change to Tab” from the context menu. Upon activation of the menu item, the button would disappear from the tab, and a new tab would appear in the tab order immediately after the tab that is the previous sibling node to the changed node, that is represented as a tab (see FIG. 37). Regarding the item “P01K01_07 Friends”, there is one prior sibling node, “P01K01_06 Family” which is a tab. See FIG. 44. When the button “P01K08_07 Friends” is changed to a tab, the user interface would change to appear as in FIG. 46, with the tab “P01K10_07 Friends” appearing immediately after “P01K10_06 Family”.

If the user can not precisely identify the exact data in the file, it becomes practical to apply generally applicable metadata tags, such as those represented in this interface by a tab label, possibly returning to add more specific tags to the file at a later time, or by another person more familar with the contents of the file. In the process described above (at the state of construction of the TAP interface as so far described), it is not possible to apply the metadata associated with a tab label to a file, because clicking on the tab label does not apply the tag represented by the tab as metadata: such clicks only serve purpose of navigating between tabs.

The addition of a special button to each tab can allow the node to be applied as a tag without requiring a click on a button that represents a child tag. See FIG. 47. Clicking on the “Apply tab as tag” button would advance to the next tab, assigning the node represented by the tab label to the file.

Additional optimizations are possible to improve efficiency. It is an accepted user interface design principle that less movement of the eyes and hands (both moving the mouse and moving between mouse and keyboard) makes for more efficient operation.

Thus far, embodiments have been introduced the change to the tab control such that a click on a button representing a tag will cause both the tag to be assigned to the file, and for the next tab to be foreground.

Referring now to FIG. 48, in the case where there is no applicable button on the foregrounded tab, mouse movement can be further reduced by putting a “Skip” button on the tab. The user is able to focus their eyes and mind on the tagging buttons instead of shifting their attention to the tab control and using the tab navigation buttons. Now, the user either applies a tag by clicking a button, or skips the tab by clicking a special button (in this case labelled “SKIP”). This button always appears in the topmost row as the leftmost button. The user will be able to develop a reflex to move the mouse to that button when they want to skip the tab, allowing efficiency of motion. Since the buttons can be rendered larger than other UI controls, and have large text, putting frequently used items onto buttons makes them easier to reach.

As a tag vocabulary grows and becomes more diverse, the likelihood increases that the user will have to skip more inapplicable tabs than click buttons on applicable tabs.

A further improvement to efficiency is to reduce the number of tabs and, if necessary, buttons on tabs, so the user has fewer choices to make and fewer inapplicable tabs to skip. This is the concept of “tagsets” and was mentioned previously. FIG. 49 shows how a structured tag vocabulary might be presented in a tree form, where the user checks off checkbox icons adjacent to the tags they want to explicitly include in the tagset. Also, as shown in FIG. 50 this would manifest itself simply as fewer tabs and buttons in the TAP user interface.

Further optimizations would be to increase the density of deeply nested tags by consolidating them onto a single higher-level ancestor tab, where such consolidation will not introduce ambiguity.

Referring to FIG. 51, under the branch of the tag vocabulary where the highest node is “P01M03_01 People”, only two child tags (namely, “P01M03_06 Family” and “P01M03_09 Neighbors” have child leaf nodes selected for inclusion in the tagset. The Arrow icon on the nodes “P01M03_06 Family” and “P01M03_09 Neighbors” indicate that these tabs are to be “bypassed”, resulting in the tab interface depicted in FIG. 52. Note the absence of tabs for the nodes “P01M03_06 Family” and “P01M03_09 Neighbors” and that the two children of “P01M03_06 Family” and one child of “P01M03_09 Neighbors” are rendered on the tab “P01M04_01 People”.

The user now has all the various tags under the branch “P01M03_01 People” available on a single tag, and need not navigate to two or more distinct tabs to thoroughly tag files.

When tagging, it is often the case that the user will need to add tags to the tag vocabulary. The “bypass” function can interfere with the user's ability to create the tag at a specific point in the overall structured tag vocabulary when using the “type on tab” method describe previously.

One method is for the user to access the structured hierarchy of the tag vocabulary in another user interface component, such as a tree control, where the entire structure is exposed for direct access. In that case, context menu entries for add new tab or add new button can be easily implemented.

Another method could be made available from the TAP. A right-click on a similar button, one that the user perceives to be in the same category of the tag they wish to create, could offer a “create new tag as sibling” function. Upon activation of the menu item, a new, blank button would appear on the foregrounded tab. The user would type as normal for creating tags on buttons as previously described, but the created tag would end up as a sibling to the tag represented by the clicked button.

Where there are many tags in many sub branches, it is not practical to use the “bypass” function: if too many tags are on a single tab, it becomes overwhelming for the user to find the specific tags required. This is basically the same principle as creating subdirectories on a file system, rather than having only a top-level folder containing hundreds or thousands of files.

It may also be the case that a given tag vocabulary is most suited to a very flat structure, or for a given class of tags, it is not desirable to alter the tag vocabulary to create a rich structure. For example, certain regional jurisdictions in contribute to the organization of the names of places in a geography-based tag vocabulary. Given a jurisdictional hierarchy of “Country” then “City”, with no jurisdictional division between, the “Country” node would get very croweded with “Cities”. Finding and working with such tags can be a very labour-intensive task.

A type of node can therefore be created which will contribute to the overall organization of the tag vocabulary, and streamline the TAP, without affecting the actual structure of the tag vocabulary: these nodes do not appear in embedded metadata, but can be used to collect a set of nodes into an arbitrary sub-group. Some examples include alphabetical or numerical divisions (“A-G”, “H-N”, “O-Z” for example). Those sub-groups can appear in the TAP in the same ways that real tags can appear, although it is most practical that they appear as “buttontabs” (described below).

Tagsets can be enhanced to provide ‘branching’ choices in the tab progression, keeping the user interface clean and compact, while still offering the user a rich set of tags from which to choose to assign to files.

Referring now to FIG. 53, the arrow icons used as indicators on nodes labeled “P01M05_06 Family” and “P01M05_09 Neighbors”. These arrows indicate that the nodes are going to affect the TAP interface by appearing as tabs only when a button is clicked. We will refer to the status of these nodes in the TAP as being “buttontabs”: they are buttons that, when clicked, instantiate tabs containing different buttons.

FIG. 54 shows the TAP interface having been configured using the setup shown in FIG. 53. The only tab present is “P01M06_01 People” due to the checkbox being checked adjacent to the node “P01M05_01 People” in FIG. 53.

While the buttons shown in FIG. 54 do not have any special ornamentation to indicate they are “buttontabs”, an icon could be displayed on the button provide information to the user that clicking this so-marked button will bring new tabs into the TAP.

A click on the button “P01M06_06 Family” will cause the user interface to change as follows:
1. The button “P01M06_06 Family” will be pressed, and while the mouse button is held down, the user interface will appear as it does in FIG. 55.
2. Upon release of the mouse button, the TAP interface will change to appear as it does in FIG. 56: a new tab appears in the tab order, immediately to the right of the tab which hosted the clicked button, and that tab will be immediately foregrounded, with its child buttons rendered.

This is feature can be used in conjunction with the “CTRL” key modifer described previously. See FIG. 55. With the CTRL key held down, a click in turn on each of the buttons “P01M07_06 Family” and “P01M07_09 Neighbors”, would cause the user interface would change to appear as it does in FIG. 57, indicating that BOTH the buttons have been clicked.

Upon release of the CTRL key, the user interface would change to appear as it does in 56. Note that the tab “P01M10_06 Family” and “P01M10_09 Neighbors” has appeared in the tab order, in the same order as they appear in the tag hierarchy shown in 47. The tab “P01M10_06 Family” is foregrounded, and the tab “P01M10_09 Neighbors” will be visited as previously described when a button is clicked on the tab “P01M10_06 Family”.

In a preferred embodiment, the invention is configured for the tagging of a single file at a time, with the next file being preloaded and presented to the user in such a way that the details of the file are more easily examined. For example, a large view of a photo is displayed in a large screen area. Multiple file selection is also contemplated by the invention, but is preferably implemented in a derivative process where only a subset of the tags relating to common characteristics of many files, such as the event or location, are to be applied.

For instance, the event or place in a photo might be something that should be associated with a significant number of photos, and also in a time-sequential selection of them. Thus the user does not have to scroll around in the thumbnail display area ensuring there were not more images not gathered into the multi-selection, because it is sufficient to verify that the image before the first selected and after the last selected image do not belong in the selection.

When tagging files individually, access to every node in the tagset may be necessary to tag files thoroughly, but when selecting many or all files, only a subset of the tags are likely to apply to all the files in the selection.

Three distinct modes of operation can be implemented, and to each tab in the tab progression, a setting can be applied so that in each of the three modes (which we will call “Batch Tag”, “Selective Tag” and “Single File Tag” modes) tabs containing buttons representing tags that are likely to apply to all, only selected or only one file respectively will be visited.

For example when tagging photos taken at a given event, tags describing the event will apply to all the photos, but specific activities might only apply to a subset of the files, and specific details might have to be applied one single file at a time.

This setting would be stored with the tag set, and different tabs would be skipped depending on the current mode and how the tab is configured for the current mode.

From time to time, during a tagging operation applied to a sequence of files, it may be determined that a specific tag is going to be applied to every file in a consecutive sequence of files. Starting at a certain time, all the files generated from that point to a specific end point may all be candidates to have a specific tag applied. To save the user the task of manually clicking, for every single file, the same button on a given tab, the button can optionally be “pinned” down.

The user would access a toolbar button or context menu item and mark the button as being “pinned” that would automatically apply the tag to every file from that time onward until deactivated later in the tagging process, after several files have been tagged.

The user would benefit from some indication in the user interface that a given button is “pinned”, such as an icon on the button, or a change in colouring of the button face or the text label on the button.

It is likely that the user will click the button accidentally and rather than have a single unmodified click event unpin the button, the user must actively choose an ‘unpin’ function, then click the button, when it is determined that particular button is not applicable to the current file and is unlikely to be applicable for upcoming files in the processing queue.

Optionally, the tab could also be automatically skipped so the user need not click the previously-described “Skip” button to navigate to the next tab. In such case, in order to unpin the button, the standard “tab navigation” controls would be used to foreground the tab hosting the pinned button, and the user would employ the “unpin” function.

Additional enhancements to this user interface can provide additional feedback to the user regarding the status of metadata:
whether the tag was embedded in the file when it was loaded into the application for tagging, or whether the tag has been newly applied;
that the tag has been used recently on another file, and may therefore be applicable to the current file
the source data type of the tag (string, number, date, etc.)
it's data storage compartment (XMP, IPTC, EXIF, etc.)
pedigree: whether the user created the tag themselves, or that the tag belongs to a third-party controlled vocabulary

For instance, the shades of brown, red and green can be used respectively to indicate the tag was already present, has been removed, or is being added. Also, the border or background colour of the tag can indicate whether the tag is part of a third party vocabulary (blue) or owned by one of the users own vocabularies (green), or discovered in a file but not yet found in a vocabulary file (orange). Orange tags might be bogus tags applied in error by other users, and included in the currently displayed file. The shape of the icon can then indicate other information about the tag, such as its compartment in the file, its data type, and whether it has contained items, a list of items, a single item, or is a leaf keyword.

Furthermore, it may be beneficial to provide the user with these types of data in a matrix: where colour of an icon indicates the pedigree and the shape of the icon indicates the data storage compartment.

The use of icons may be extended to the tab labels: when a tab is foregrounded, the buttons are visible and any icons used on buttons inform the user according to the icons on the buttons. But when a tab is not foregrounded, the buttons on said tab are not visible, and also not visible is potentially important information about the tags. Icons rendered on the tabs can provide the user with information about the nature of the tags hosted on that tab; an icon on the tab can sometimes allow the user to not need to navigate to the tab and examine the buttons on it directly.

As new user interface paradigms are introduced, the invention can be applied to new devices that provide those user interface paradigms.

For example, the new “multi-touch” interface made popular by the Apple iPhone and iPod Touch provide new ways to interact with files being tagged and to assign metadata to said files. In the following description, we will refer to these devices and user interface paradigms generally as “iTouch”. Some of the actions described will be with reference to their common names as used to describe operations on the iTouch user interface for existing applications that run on the iTouch.

The TAP process based on the use of a tabbed dialog, described above, has an analogue in a multi touch interface: clicking on directional arrows on scroll bars etc. can be performed with a “flick” action. Zooming in on a timeline or thumbnail view of a file would be performed by the “pinch” action.

The orientation of the device can also be used to determine which aspect or orientation of the user interface to display, and a change of orientation can be used as an “event” initiator, if the device has technology known as “accelerometers” built in to the device.

For example, the iTouch responds to changes in orientation. If the device is held upright with the longest measurement axis of the device roughly parallel to the force of gravity, when the orientation is changed so the second-longest measurement axis of the device is now roughly parallel to the force of gravity, the change in orientation causes a software event that can change the orientation of the objects displayed on the screen, or change the display entirely to a different view of the data, or cause a reorganization of the user interface.

Typically, such devices have limited screen resolutions much smaller than that of a personal computer screen, but over time, it is expected that devices that use multi-touch interfaces and accelerometers will include personal computers, such as the Apple Macintosh Air. The multi-touch interface does not overlay the screen in that case, but still, multi-touch operations are possible.

For devices with a limited screen size, it is important to present only the bare essentials required for tagging to the user at a given time: the TAP interface is particularly useful here: the user is prompted to choose from a short-list of tags in a given category, then a new category is presented, from which they choose from a short list, and so on. The limited resolution does not have the same degree of negative impact as other metadata application user interface paradigms, such as trees, lengthy lists, etc.

The size of many portable devices typically restrict the user to an on-screen keyboard or handwriting recognition, or a very cramped “thumb keyboard” on which rapid text entry is impractical or impossible. The TAP methodology reduces the requirement to key text on a keyboard substantially, and is therefore well suited to use on portable devices, especially those with touch screens. An example TAP interface design suited to iTouch devices is shown in FIGS. 59 through 62.

In another embodiment, the present invention provides guidance for the application of a specific tag in the broader context of the tag vocabulary. Beyond the general description of the tag, this type of guidance has particular value while the user is tagging files. This guidance pertains to the specific characteristics of the file the user should observe to best determine the correct subtag or parameter value to use. A novice user may be overwhelmed by the variety of content they must consider to apply a single tag. This type of guidance helps the user focus on particular characteristics relevant to a specific tag. Conversely, a user may be provided with guidance as to which characteristics of the file to IGNORE to determine which subtags or parameter values to assign to the file, such guidance implying that certain characteristics that may be relevant to the current tag are more relevant to another tag. The current invention provides a platform for standardization of such guidance.

The present invention is not limited to the development of new software, user interfaces, or operating systems. One skilled in the art may adapt commercially available metadata application tools, and metadata management features of those tools, such as Adobe LightRoom, Adobe Bridge, Windows Photo Gallery, etc., provide functionality (eg. ‘TAP mode’) according to the present invention. Specifically, any of the above-mentioned legacy commercially available metadata programs, may have their existing metadata application features adapted according to “TAP mode” and/or “Tagset mode”.

In another embodiment of the invention, the methods described above may be adapted for the association of one or more choices from a structured list of choices with a representation of an item.

Examples of the representation and choices include, but are not limited to, a computer rendering of a media file, in which case the choices may be metadata tags; a textual, iconic or image representation on a computer of a physical or electronic document, in which case the choices may be metadata associate with the document; a textual, iconic or image representation on a computer of a survey question, in which case the choices may be candidate answers to the survey question; and a textual, iconic or image representation on a computer of a physical object such as a pizza, in which case the choices may be toppings that a customer may select to be included.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

Therefore what is claimed is:

1. A computer readable medium encoded with computer-executable instructions which, when executed by a computer, perform a method of associating a file with one or more metadata tags, the method comprising:
a) displaying to a user a metadata user interface for the selection of said one or more metadata tags from a set of tags, wherein said set of tags comprises a hierarchal structure with one or more nested tag node subsets;
b) activating a first primary tag node as an active tag node;
c) presenting a tag node subset belonging to said active tag node to said user and receiving input from said user, wherein said user may select a tag to associate with said file by selecting a leaf tag node, or said user may modify said active tag node by choosing an intermediate tag node or a primary tag node, wherein said chosen tag node is activated as said active tag node;
d) repeating step (c) until a leaf tag node is selected;
e) activating as an active tag node a primary tag node that had not been activated in a previous step, and subsequently repeating (c)-(d), until all primary tag nodes have been activated or until said method is terminated by an optional user control; and
f) associating said selected metadata tags with said file.

2. The computer readable medium according to claim 1 wherein said set of tags is a pre-defined data structure loaded from a computer readable medium.

3. The computer readable medium according to claim 1 wherein said when performing step (c), a new tag node may be optionally created by said user.

4. The computer readable medium according to claim 3 wherein said new tag node is created by keystrokes entered by said user, wherein said keystrokes activate a user interface prompt that records said keystrokes and saves said keystrokes as a new tag node within a tag node subset belonging to said active tag node.

5. The computer readable medium according to claim 3 wherein said new tag node is a leaf tag node.

6. The computer readable medium according to claim 3 wherein said new tag node is an intermediate tag node.

7. The computer readable medium according to claim 3 wherein said new tag node may be configured to be a leaf tag node or an intermediate tag node.

8. The computer readable medium according to claim 7 wherein said new tag node may be configured to be a leaf tag node or an intermediate tag node by a right-click mouse action.

9. The computer readable medium according to claim 1 wherein when performing step (c), an intermediate tag node may be selected as a tag node to associate with said file, wherein subsequent step (d) is executed as if a leaf node was selected in step (c).

10. The computer readable medium according to claim 1 wherein steps (c) and (d) may be skipped by said user by activating a button or context menu item in said user interface.

11. The computer readable medium according to claim 1 wherein steps (c) and (d) may be skipped by selecting another primary tag node by clicking said another primary tag node with a mouse.

12. The computer readable medium according to claim 1 wherein when performing step (c), tag nodes belonging to intermediate tag nodes within said tag node subset are not displayed.

13. The computer readable medium according to claim 1 wherein when performing step (c), a previously displayed intermediate tag node to which said active tag node does not belong is not displayed.

14. The computer readable medium according to claim 1 wherein when performing step (c), previously displayed intermediate or leaf tag nodes that were not selected are not displayed.

15. The computer readable medium according to claim 1 wherein said user control is a button or context menu item in said user interface.

16. The computer readable medium according to claim 1 wherein prior to performing step (b) for the first time, all primary tag nodes are displayed.

17. The computer readable medium according to claim 16 wherein when performing step (b) or step (e), said user may select a primary tag node as said active tag node.

18. The computer readable medium according to claim 16 wherein said primary tag nodes are serially identified in the order that they appear in said first tag node subset.

19. The computer readable medium according to claim 1 wherein when performing step (c), multiple intermediate tag nodes may be chosen from said tag node subset, and wherein after choosing said multiple intermediate tag nodes, steps (c)-(d) are repeated for each intermediate tag node chosen.

20. The computer readable medium according to claim 1 wherein when performing step (c), more than one leaf tag node from said tag node subset may be selected.

21. The computer readable medium according to claim 1 wherein said user interface further provides a list of all selected tags to be associated with said file.

22. The computer readable medium according to claim 21 wherein said list is provided as a tag node subset of an additional primary tag node.

23. The computer readable medium according to claim 21 wherein one or more of said selected tags may be de-selected by said user.

24. The computer readable medium according to claim 23 where said list is presented as an additional tag node subset belonging to an additional primary tag node, wherein said additional tag node subset comprises said selected tags to be associated with said file.

25. The computer readable medium according to claim 1 wherein when performing step (c), said user may configure a selected tag node to be associated with said file and subsequent additional files.

26. The computer readable medium according to claim 25 wherein said selected tag node may be configured by activating a button or context menu item in said user interface.

27. The computer readable medium according to claim 1 wherein said file is selected from the list comprising audio file, digital photograph file and digital video file.

28. The computer readable medium according to claim 1 wherein said user interface further comprises an interface for selecting said set of tags from a superset of tags, wherein said superset of tags is stored in a hierarchal structure comprising one or more nested tag node subsets, and wherein said superset of tags comprises primary tag nodes forming a first tag node subset, intermediate tag nodes, and leaf tag nodes terminating said hierarchal structure.

29. The computer readable medium according to claim 28 wherein said interface for selecting said set of tags is a graphical representation of a tree structure of said superset of tags, and wherein individual tag nodes may be selected or de-selected for presentation to said user in step (c).

30. The computer readable medium according to claim 29 wherein said tag nodes are displayed with a user-selectable check box.

31. The computer readable medium according to claim 30 wherein said checkbox is a three-state checkbox, and wherein said three states indicate whether none, some, or all tag nodes belonging to a given tag node are included in said set of tags.

32. The computer readable medium according to claim 29 wherein said graphical representation of said tree structure may be fully or partially expanded by said user.

33. The computer readable medium according to claim 28 wherein when performing step (c), an indication is provided to said user if one or more tag nodes within said tag node subset have been de-selected.

34. The computer readable medium according to claim 33 wherein when performing step (c), said user may select tag nodes from said superset of tag nodes to be included in said set of tags.

35. The computer readable medium according to claim 28 wherein said set of tag nodes comprises a data structure.

36. The computer readable medium according to claim 35 wherein said data structure is a pre-defined data structure loaded from a computer readable medium.

37. The computer readable medium according to claim 35 wherein said data structure is a composite data structure comprising two or more pre-defined data structures loaded from a computer readable medium.

38. The computer readable medium according to claim 1 wherein a visual indication is provided to said user of primary nodes that have not yet been activated as said active tag node.

39. The computer readable medium according to claim 19 wherein a visual indication is provided to said user of said multiple intermediate tag nodes.

40. The computer readable medium according to claim 1 wherein said metadata user interface displays tag nodes to said user in a tree structure.

41. The computer readable medium according to claim 40 wherein when selecting a file for which metadata tags have been previously selected, said tree structure is expanded to show all tag node subsets comprising a previously selected tag node.

42. The computer readable medium according to claim 40 wherein an already selected tag node may be de-selected by the user.

43. The computer readable medium according to claim 1 wherein said primary and intermediate tag nodes are presented to said user as tabs on multi-pane window, wherein a selection of a tab activates a single pane corresponding to said tab, wherein leaf nodes belonging to a given tag node are represented as buttons on said single pane corresponding to said given tag node, and wherein intermediate tag nodes belonging to said given tag node are represented as tabs on said multi-pane window.

44. The computer readable medium according to claim 43 wherein when performing step (c), an additional button is presented to said user in said single pane wherein the selection of said additional button causes a tab corresponding to said single pane to be selected as a tag to associate with said file, and wherein subsequent step (d) is executed if a leaf tag node was selected in step (c).

45. The computer readable medium according to claim 43 wherein when performing step (c), a button may be converted into a tab by said user.

46. The computer readable medium according to claim 43 wherein said tabs presented to said user are ordered within said multi-pane window in a linear chain by listing tabs corresponding to said tag nodes in the order that said tag nodes appear vertically within a tree structure.

47. The computer readable medium according to claim 43 wherein when performing step (c), tabs corresponding to intermediate tag nodes belonging to a primary tag node can be configured so that said tabs are not presented, and buttons within panes corresponding to said tabs are presented in a single pane corresponding to said primary tag node.

48. The computer readable medium according to claim 47 wherein a new button may be optionally created by said user, wherein a tag node corresponding to said new button and a tag node corresponding to one of said buttons within panes corresponding to said tabs belong to a common tag node, wherein said user may select said one of said buttons within panes corresponding to said tabs with a mouse and choose to create said new button from a context menu.

49. The computer readable medium according to claim 43 wherein when performing step (c), a tab corresponding to a tag node belonging to said active tag node may be presented to said user as an additional button within said pane instead of a tab, wherein a selection of said button causes said a tag node subset belonging to said tab to become said active tag node subset.

50. The computer readable medium according to claim 49 wherein said additional button is visually distinct from said buttons representing leaf nodes.

51. The computer readable medium according to claim 43 wherein when performing step (c), more than one additional button may be selected by said user, and a tag node subset belonging to a first selected additional button becomes said active tag node subset, and intermediate tag nodes belonging to further selected additional buttons are shown as tabs on said multi-pane window.

52. A computer readable medium encoded with computer-executable instructions which, when executed by a computer, perform a method of associating a representation of an item with one or more choices, wherein said representation of said item is encoded on a computer readable medium, and wherein the method comprises:
a) displaying a user interface to a user for the selection of said one or more choices from a set of choices, wherein said set of choices comprises a hierarchal structure with one or more nested node subsets;
b) activating a first primary node as an active node;
c) presenting a node subset belonging to said active node to said user and receiving input from said user, wherein said user may select a choice to associate with said representation of said item by selecting a leaf node, or said user may modify said active node by choosing an intermediate node or a primary node, wherein said chosen node is activated as said active node without requiring further input from said user;
d) repeating step (c) until a leaf node is selected;
e) activating as an active node a primary node that had not been activated in a previous step, and subsequently repeating (c)-(d), until all primary nodes have been activated or until said method is terminated by an optional user control; and
f) associating said selected choices with said representation of said item.

53. A computer readable medium encoded with computer-executable instructions which, when executed by a computer, perform a method of associating a file with one or more metadata tags, the method comprising:
a) displaying to a user a metadata user interface for the selection of said one or more tags from a set of tags, wherein said set of tags comprises a hierarchal structure with one or more nested tag node subsets, and wherein said set of tags comprises primary tag nodes forming a first tag node subset, intermediate tag nodes, and leaf tag nodes terminating said hierarchal structure;
b) presenting said primary and intermediate tag nodes to said user and receiving input from said user, wherein a selection of a primary or intermediate tag node by said users causes leaf tag nodes belonging to said primary or intermediate tag node to be displayed;
c) identifying a first primary tag node as an active tag node;
d) presenting leaf tags nodes belonging to said active tag node, and receiving input from said user, wherein said user may select a tag to associate with said file by selecting a leaf tag node, wherein said selection of said leaf tag node causes another primary or intermediate tag node to be identified as said active tag node, or wherein said user may choose a different primary or intermediate tag node to identify as said active tag node; and
e) repeating step (d) until all primary and intermediate tag nodes have identified or until said method is terminated by an optional user control; and
f) associating said metadata tags with said file.

54. The computer readable medium according to claim 53 wherein in step f), said selected metadata tags are stored on a computer readable medium in association with said file.

55. The computer readable medium according to claim 53 wherein set of tags is a pre-defined data structure loaded from a computer readable medium.

56. The computer readable medium according to claim 53 wherein said when performing step (d), a leaf tag node may be optionally created by said user.

57. The computer readable medium according to claim 56 wherein said new leaf tag node is created by keystrokes entered by said user, wherein said keystrokes activate a user interface prompt that records said keystrokes and saves said keystrokes as a new leaf tag node.

58. The computer readable medium according to claim 53 wherein said user control is a button or context menu item in said user interface.

59. The computer readable medium according to claim 53 wherein when performing step (d), more than one leaf tag node may be selected.

60. The computer readable medium according to claim 53 wherein when performing step (d), a leaf node may be converted into an intermediate tag node by said user.

61. The computer readable medium according to claim 53 wherein said user interface further provides a list of all selected buttons to be associated with said file.

62. The computer readable medium according to claim 61 wherein said list is provided as buttons within a pane corresponding to an additional tab.

63. The computer readable medium according to claim 62 wherein one or more of said buttons with a pane corresponding to an additional tab may be de-selected by said user.

64. The computer readable medium according to claim 61 wherein a leaf tag node newly selected by said user is uniquely represented.

65. The computer readable medium according to claim 61 wherein when performing step (d), said user may configure a selected leaf tag node to be associated with said file and subsequent additional files.

66. The computer readable medium according to claim 65 wherein said selected leaf tag node may be configured by activating a button or context menu item in said user interface.

67. The computer readable medium according to claim 53 wherein when performing step (d), a leaf tag, node that was recently selected when associating a previous file with one or more metadata tags is uniquely represented.

68. The computer readable medium according to claim 53 wherein when performing step (d), a tag node is uniquely represented according to the source data type of the tag corresponding to said tag node.

69. The computer readable medium according to claim 53 wherein when performing step (d), a tag node is uniquely represented according to a data storage compartment of the tag corresponding to said tag node.

70. The computer readable medium according to claim 53 wherein when performing step (d), a tag node created by said user is represented differently than a tag node created by a third-party.

71. The computer readable medium according to claim 53 wherein said file is selected from the list comprising audio file, digital photograph file and digital video file.

72. The computer readable medium according to claim 53 wherein said user interface further comprises an interface for selecting said set of tags from a superset of tags, wherein said superset of tags is stored in a tree structure comprising one or more nested tag node subsets, and wherein said superset of tags comprises primary tag nodes forming a first tag node subset, intermediate tag nodes, and leaf tag nodes terminating said tree structure.

73. The computer readable medium according to claim 72 wherein said interface for selecting said set of tags is user-configurable graphical representation of a tree structure of said superset of tags, and wherein individual tag nodes may be selected or de-selected for presentation to said user in step (d).

74. The computer readable medium according to claim 73 wherein said tag nodes are displayed with a user-selectable check box.

75. The computer readable medium according to claim 73 wherein said check box is a three-state checkbox, and wherein said three states indicate whether none, some, or all tag nodes belonging to a given tag node are to included in said set of tags.

76. The computer readable medium according to claim 75 wherein said graphical representation of said tree structure may be fully or partially expanded by said user.

77. The computer readable medium according to claim 75 wherein when performing step (d), an indication is provided to said user if one or more tag nodes have been de-selected.

78. The computer readable medium according to claim 77 wherein when performing step (d), said user may select a tag node from said superset of tag nodes to be included in said set of tags.

79. The computer readable medium according to claim 53 wherein said set of tag nodes comprises a data structure.

80. The computer readable medium according to claim 79 wherein said data structure is a pre-defined data structure loaded from a computer readable medium.

81. The computer readable medium according to claim 79 wherein said data structure is a composite data structure comprising two or more pre-defined data structures loaded from a computer readable medium.

82. The computer readable medium according to claim 53 wherein said primary and intermediate tag nodes are presented to said user as tabs on multi-pane window, wherein a selection of a tab activates a single pane corresponding to said tab, and wherein leaf nodes belonging to a given tag node are represented as buttons on said single pane corresponding to said given tag node, and wherein an active tab corresponds to said active tag node.

83. The computer readable medium according to claim 82 wherein said tabs are ordered within said multi-pane window in a linear chain by listing tabs corresponding to said tag nodes in the order that said tag nodes appear vertically within a tree structure.

84. The computer readable medium according to claim 82 wherein an additional button is provided in said pane, wherein the selection of said button causes an active tab to be selected as a tag node to associate with said file, wherein said selection of said button causes an adjacent tab to be made said active tab.

85. The computer readable medium according to claim 82 wherein an additional button is provided in said pane, wherein the selection of said button causes an adjacent tab to be made said active tab.

86. The computer readable medium according to claim 82 wherein when performing step (b), tabs corresponding to intermediate tag nodes belonging to a primary tag node can be configured so that said tabs are not presented, and buttons within panes corresponding to said tabs are presented in a single pane corresponding to said primary tag node.

87. The computer readable medium according to claim 52 wherein said user is two or more users, and wherein user interfaces are provided to each of said two or more users, and wherein in step (c), any user of said two or more users may select or chose a node, and wherein the result of a choice or selection made by said any user is presented on said user interfaces.

88. The computer readable medium according to claim 86 wherein a new button may be optionally created by said user, wherein a tag node corresponding to said new button and a tag node corresponding to one of said buttons within panes corresponding to said tabs belong to a common tag node, wherein said user may select said one of said buttons within panes corresponding to said tabs with a mouse and choose to create said new button from a context menu.

89. The computer readable medium according to claim 82 wherein when performing step (d), a tab belonging to said active tab may be presented to said user as an additional button within said pane instead of a tab, wherein a selection of said button causes said tab belonging to said active tab to become said active tab.

90. The computer readable medium according to claim 89 wherein said additional button is visually distinct from said buttons representing leaf nodes.

91. The computer readable medium according to claim 82 wherein when performing step (d), more than one additional button may be selected by said user, and a first selected additional button becomes said active tab, and further selected additional buttons are shown as tabs on said multi-pane window.

92. The computer readable medium according to claim 1 wherein said file is rendered during step (c).

93. The computer readable medium according to claim 53 wherein said file is rendered during step (d).

94. The computer readable medium according to claim 1 wherein descriptive documentation is provided to said user for each tag node.

95. The computer readable medium according to claim 53 wherein descriptive documentation is provided to said user for each tag node.

96. The computer readable medium according to claim 53 wherein in step f), said selected metadata tags are stored on a computer readable medium in association with said file.

97. A computer readable medium encoded with computer-executable instructions which, when executed by a computer, perform a method of associating a file with one or more metadata tags, the method comprising:
a) displaying to a user a metadata user interface for the selection of said one or more tags from a set of tags, wherein said set of tags comprises a hierarchal structure of tag nodes with one or more nested tag node subsets;
b) guiding said user through a series of steps in which individual tag node subsets are presented to said user wherein said user may select a tag node to associate with said file; and
c) associating said selected metadata tags with said file.

98. A user interface embodied on one or more computer-readable media and executable on a computer, wherein a user may select one or more metadata tags from a set of tags to associate with a file, wherein said set of tags comprises a hierarchal structure of tag nodes with one or more nested tag node subsets, and wherein said user interface comprises:
an item presentation area for displaying or rendering a visual representation of a file; and
a presentation area configured for the display of said tag node subsets, wherein said user is guided through a set of steps in which individual tag node subsets are presented to said user, and wherein said user may select one or more tags nodes displayed in said presentation area to associate with said file;
wherein said tags selected by said user are associated with said file.

99. The user interface according to claim 98 wherein the selection of a tag node to which additional tag nodes belong causes said additional tag nodes to be displayed.
